(19) United States
(12) Patent Application Publication
(10) Pub. No.: US 2026/0299973 A1
(43) Pub. Date: Oct. 1, 2026

(54) GENERATING CONSOLIDATED USER INTERFACES FOR PSEUDO ACCOUNTS

(71) Applicant: Chime Financial, Inc., San Francisco, CA (US)

(72) Inventors: Melissa Hamilton, San Francisco, CA (US); Ryan King, San Francisco, CA (US); Jacques Pierre Fuentes, Richmond, VA (US)

(21) Appl. No.: 19/096,369

(22) Filed: Mar. 31, 2025

(51) Int. Cl. G06F 9/451; G06F 3/04842; G06Q 20/10

(52) U.S. Cl. CPC G06F 9/451; G06F 3/04842; G06Q 20/10

(57) ABSTRACT

The present disclosure relates to systems, non-transitory computer-readable media, and methods for creating and implementing a pseudo account for a collection of digital asset accounts of a client device. For example, one or more embodiments involve generating a deterministic consolidated account structure by consolidating features of multiple underlying digital asset accounts. Some embodiments involve presenting the deterministic consolidated account structure as a single digital asset account representing the underlying digital asset accounts. Further, some embodiments involve using automatic account sweeping protocols and to move digital assets among the underlying accounts and consolidated user interface features to graphically represent the deterministic consolidated account structure in support of its use and presentation as a single digital asset account.

### BRIEF DESCRIPTION OF THE DRAWINGS

This disclosure will describe one or more embodiments of the invention with additional specificity and detail by referencing the accompanying figures. The following paragraphs briefly describe those figures, in which:

FIG. 1 illustrates an overview diagram of the device account consolidation system creating and presenting a pseudo account in accordance with one or more embodiments.

FIGS. 2A-2B illustrate the device account consolidation system generating a deterministic consolidated account structure for a client device in accordance with one or more embodiments.

FIG. 3 illustrates the device account consolidation system generating a deterministic account identifier in accordance with one or more embodiments.

FIG. 4 illustrates the device account consolidation system generating a consolidated digital asset value in accordance with one or more embodiments.

FIG. 5A illustrates the device account consolidation system generating consolidated transfer information in accordance with one or more embodiments.

FIGS. 5B-5C illustrate the device account consolidation system using transfer information associated with a deterministic consolidated account structure in accordance with one or more embodiments.

FIGS. 6A-6B illustrate the device account consolidation system modifying a consolidated digital asset value of a deterministic consolidated account structure in accordance with one or more embodiments.

FIGS. 7A-7B illustrate the device account consolidation system enabling the deterministic consolidated account structure to be selected for a transfer in accordance with one or more embodiments.

FIG. 8 illustrates an overview of the device account consolidation system implementing one or more automatic account sweeping protocols in accordance with one or more embodiments.

FIGS. 9A-9F illustrate the device account consolidation system executing various automatic account sweeping protocols in accordance with various embodiments.

FIG. 10 illustrates an example system environment in which a device account consolidation system can operate in accordance with one or more embodiments.

FIG. 11 illustrates a schematic diagram of a computer platform for implementing a device account consolidation system in accordance with one or more implementations.

FIG. 12 illustrates a flowchart of a series of acts for executing an atomic transfer using an automatic account sweeping protocol in accordance with one or more embodiments.

FIG. 13 illustrates a flowchart of a series of acts for generating a consolidated digital report for a deterministic consolidated account structure of a client device in accordance with one or more embodiments.

FIG. 14 illustrates a flowchart of a series of acts for generating a filtered consolidated digital report for a collection of digital asset accounts of a client device in accordance with one or more embodiments.

FIG. 15 illustrates a block diagram of a computing device for implementing one or more embodiments of the present disclosure.

FIG. 16 illustrates an example environment for the device account consolidation system in accordance with one or more embodiments.

### DETAILED DESCRIPTION

This disclosure describes one or more embodiments of a device account consolidation system 100 that creates, within a digital system and for a client device, a pseudo account structured on multiple underlying accounts and supported by underlying asset sweeps. For example, in some embodiments, the device account consolidation system creates the pseudo account by generating an account structure that consolidates features and data from the underlying accounts. Thus, the device account consolidation system 100 can use a consolidated user interface to present the pseudo account to the client device as a single account representing the multiple underlying accounts. In some cases, the device account consolidation system 100 streamlines the pseudo account by sweeping digital assets among underlying accounts via various automated protocols and atomic transfers. Additionally, the device account consolidation system 100 can implement the pseudo account without maintaining the pseudo account within storage. For instance, in some embodiments, the device account consolidation system 100 creates the pseudo account on the fly—such as when the client device accesses the digital system (e.g., via a client application). In some cases, the device account consolidation system 100 creates the pseudo account deterministically.

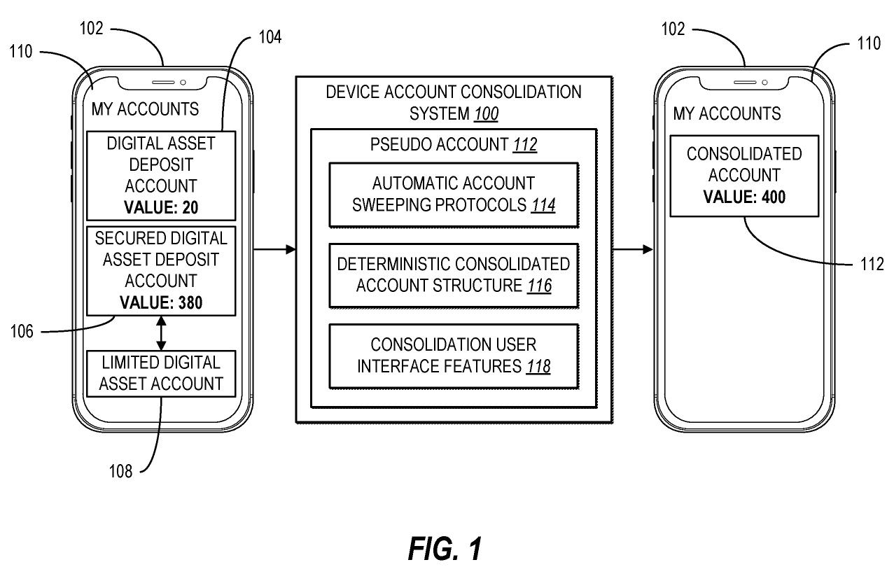

FIG. 1 illustrates an overview diagram of the device account consolidation system 100 creating and presenting a pseudo account in accordance with one or more embodiments. Indeed, as shown in FIG. 1, a client device 102 is associated with (e.g., is the owner, administrator, or user of) a collection of digital asset accounts. In particular, FIG. 1 illustrates the client device 102 being associated with a digital asset deposit account 104, a secured digital asset deposit account 106, and a limited digital asset account 108. As shown, the secured digital asset deposit account 106 is linked to the limited digital asset account 108. For instance, as will be discussed more below, in some implementations, the secured digital asset deposit account 106 sets a threshold transmission limit for the limited digital asset account 108 (e.g., a limit on the number or amount of digital assets that can be transferred out of the limited digital asset account 108). While FIG. 1 illustrates a particular collection of digital asset accounts, it should be noted that the device account consolidation system 100 can operate with various collections of digital asset accounts in various embodiments, including collections have more, fewer, and/or alternative digital asset accounts.

As suggested by FIG. 1, in some cases (e.g., where a pseudo account is not used), the collection of digital asset deposit accounts associated with the client device 102 is presented within a graphical user interface 110 of the client device 102. For instance, upon accessing a client application for managing digital asset accounts (e.g., a digital system that maintains the collection of digital asset accounts), the client device 102 displays the collection of digital asset account. In particular, as indicated by FIG. 1, the client device 102 displays the digital asset accounts from the collection simultaneously such that they are individually accessible through the graphical user interface 110. In some cases, the client device 102 displays a digital asset account by displaying a visual element for the digital asset account. In some cases, the visual element is interactive such that, upon a selection of visual element, the client device displays additional information (e.g., transfer information) and/or options for the corresponding digital asset account.

As further illustrated by FIG. 1, the device account consolidation system 100 creates a pseudo account 112 (e.g., a consolidated digital asset account) for the client device 102. In one or more embodiments, the device account consolidation system 100 creates the pseudo account 112 as a single digital asset account that represents the collection of digital asset accounts associated with the client device 102. For instance, the pseudo account 112 can include a consolidated representation of the digital asset deposit account 104, the secured digital asset deposit account 106, and the limited digital asset account 108. In some cases, the device account consolidation system 100 uses the pseudo account 112 as a high-level (e.g., umbrella) account through which the underlying accounts can be viewed and/or managed.

Indeed, as shown in FIG. 1, the device account consolidation system 100 provides the pseudo account 112 for display within the graphical user interface 110 of the client device 102. In some cases, the device account consolidation system 100 provides the pseudo account 112 for display by providing a graphical representation of the pseudo account 112 for display. In some cases, the visual element for the pseudo account 112 is interactive. For instance, upon detecting a selection of the visual element, the device account consolidation system 100 can provide additional information and/or options regarding the pseudo account 112. In some cases, the additional information and/or options correspond to or are derived from the underlying accounts, but the device account consolidation system 100 presents the additional information and/or options in association with the pseudo account 112.

As further illustrated in FIG. 1, the device account consolidation system 100 generates and implements the pseudo account 112 using automatic account sweeping protocols 114, a deterministic consolidated account structure 116, and consolidation user interface features 118. In one or more embodiments, the device account consolidation system 100 uses the automatic account sweeping protocols 114 to support the pseudo account 112. For instance, the device account consolidation system 100 can use the automatic account sweeping protocols 114 to transfer digital assets among the underlying digital asset accounts to streamline maintenance of the pseudo account 112. In some cases, the device account consolidation system 100 uses an automatic account sweeping protocol to execute an atomic transfer in which the digital assets being moved are inaccessible until the transfer is complete.

In some embodiments, the device account consolidation system 100 creates the deterministic consolidated account structure 116 to provide a structure that covers and incorporates the underlying digital asset accounts but presents the pseudo account 112 as a single account (e.g., a consolidated digital asset account). Indeed, as will be discussed below, the device account consolidation system 100 can use the deterministic consolidated account structure 116 as the structural representation of the pseudo account 112 (e.g., the structure that is ultimately viewed, managed, and interacted with). Further, in some cases, the device account consolidation system 100 uses the consolidation user interface features 118 to present the pseudo account 112 (e.g., present the deterministic consolidated account structure 116) via the client device 102. Indeed, in some cases, via the consolidation user interface features 118, the device account consolidation system 100 incorporates and provides various visual elements that are provided to the client device 102. More detail regarding these elements of the pseudo account 112 will be discussed below.

In one or more embodiments, the device account consolidation system 100 provides technological improvements or advantages relative to existing systems. Indeed, existing systems suffer from a number of technical deficiencies when it comes to managing and presenting digital asset accounts, particularly with regard to efficiency and security. For instance, as previously suggested, existing systems typically provide an inefficient, disjointed presentation of digital asset accounts associated with client devices. In particular, existing systems tend to present each digital asset account individually, requiring that each account’s details be viewed or managed separately. As a result, existing systems typically require a significant number of user interactions to obtain a big-picture understanding of the collection of digital asset accounts of a client device or to configure the collection to operate as desired. As one example, to view the transfers that have occurred across a collection of accounts of a client device, existing systems often require a separate set of user interactions with the client device to access and view the separate transfer history of each account.

Additionally, existing systems often risk security failures when transferring digital assets between digital asset accounts, including between digital asset accounts of the same client device. For instance, many existing systems transfer digital assets between accounts using processes that leave large windows of time between the event triggering the transfer and the digital assets being settled into the destination account. Such timing windows present the risk of digital assets being selected for conflicting transfers. For instance, a digital asset that has been selected for transfer from a first account to a second account may—before that transfer is completed—also be selected for a separate transfer from the first account to a third account. Thus, these existing systems are often vulnerable to disruptions in the tracking of digital assets or vulnerable to the loss of digital assets by those that fall victim to the committing of those digital assets when they have already been committed elsewhere.

One or more embodiments of the device account consolidation system 100 provide several advantages over existing systems. For example, one or more embodiments of the device account consolidation system 100 improve the efficiency of implementing computing devices when compared to existing systems. In particular, by generating a pseudo account (e.g., via a deterministic consolidated account structure) that consolidates the data and features of multiple underlying digital asset accounts, the device account consolidation system 100 creates an efficient, unified representation of the underlying accounts. With the pseudo account, the device account consolidation system 100 can provide a consolidated view of relevant information across the underlying accounts upon request. The device account consolidation system 100 can further provide consolidated access to features that incorporate or affect one or more of the underlying accounts. In many instances, the device account consolidation system 100 provides efficient access to the information and/or features via a consolidated graphical user interface, such as by providing a graphical representation of one digital asset account (e.g., the pseudo account). Thus, rather than requiring separate user interactions to access the data and/or features of separate digital asset accounts, the device account consolidation system 100 surfaces the information and/or features within a single pseudo account, reducing the amount of user interaction needed for access.

Additionally, one or more embodiments of the device account consolidation system 100 improve the security of implementing computing devices when compared to existing systems. In particular, embodiments of the device account consolidation system 100 reduce the security risks that are typically present under existing systems when transferring digital assets between digital asset accounts. For instance, by implementing atomic transfers in which digital assets are inaccessible until settled into their destination account, the device account consolidation system 100 can prevent the digital assets from being committed for transfer before a previous commitment has been completed. Thus, the device account consolidation system 100 can use atomic transfers to reduce. the risk of loss or tracking failure.

As illustrated by the foregoing discussion, the present disclosure utilizes a variety of terms to describe features and advantages of the device account consolidation system 100. Additional detail is now provided regarding the meaning of such terms. For example, as used herein, the term “digital system” refers to a collection of digital services and/or features. In particular, a digital system can refer to a digital platform that provides accessibility to one or more services and/or features via a computing device, such as a client device. For instance, a digital system can include a software application that can be downloaded to or otherwise accessed by a computing device. To illustrate, in some cases, a digital system is accessible by a client application of a client device. In some instances, a digital system includes the client application. Further, in some implementations, the services and/or features of the digital system correspond to the management of digital asset accounts.

Additionally, as used herein, the term “digital asset” includes a resource that exists in a digital format and is associated with some value. In particular, a digital asset includes a digital resource that can be generated, managed, viewed, transferred, and/or interacted with digitally. In some cases, a digital asset represents or is associated with a physical asset. For example, a digital asset can include a digital title representing ownership of a physical asset or can include a digital representation of fiat currency. In some instances, a digital asset includes a resource that is uniquely digital, such as a cryptocurrency or a non-fungible token (NFT).

Further, as used herein, the term “digital asset account” refers to an account that is associated with a client device for the management (e.g., storage and/or use) of digital assets of the client device. For instance, a digital asset account can refer to an account that is registered with a digital system and mapped to a particular client device for the management (e.g., storage and/or use) of digital assets maintained or tracked by the digital system. The digital asset account can enable the corresponding client device to interact with the digital system, such as by requesting access to services and/or features available through the digital system. In some cases, different digital asset accounts (e.g., digital asset accounts of different account types) offer access to different sets of services and/or features. Further, in some embodiments, a digital asset account includes multiple component accounts (e.g., sub-accounts). In some cases, a digital asset account can include an account that is external to a digital system but communicates with the digital system (e.g., communicates with a digital asset account of the digital system), access services and/or features of the digital system, or provides access to services and/or features to the digital system.

As used herein, the term “digital asset deposit account” includes a digital asset account that allows for the direct storage and use of digital assets. For instance, a digital asset deposit account can include a digital asset account to which digital assets can be deposited and from which digital assets can be directly withdrawn or used. For instance, in some cases, a digital asset deposit account can be designated as a source of one or more digital assets to be transferred in an exchange with an external account (e.g., a digital asset account associated with a different client device). To illustrate, in some instances, a digital asset deposit account includes a debit, checking or savings account.

Additionally, as used herein, the term “secured digital asset deposit account” includes a digital asset account that is linked to another digital asset account. For instance, a secured digital asset deposit account can include a digital asset account that is linked to a limited digital asset account and stores digital assets that are used to support or secure the limited digital asset account. In some cases, the secured digital asset account sets a threshold transmission limit for the limited digital asset account.

Further, as used herein, the term “limited digital asset account” includes a digital asset account that has a limited utilization of digital assets determined based on digital assets that are stored in another digital asset account. For instance, in some cases, a limited digital asset account is linked to a secured digital asset account and uses digital assets based on a level of digital assets within the secured digital asset account. In other words, a client device can involve the limited digital asset account in transfers for using one or more digital assets based on digital assets stored in the secured digital asset deposit account. In some cases, a limited digital asset account is restricted in the transfers that can be made via a threshold transmission limit. For example, the limited digital asset account can include a credit account where the credit limit is set based on assets within a secured deposit account.

In some embodiments, a limited digital asset account includes a credit-based account. Thus, in some cases, one or more digital assets are committed to a transfer by a limited digital asset account via a credit, and the secured digital asset deposit account contributes the digital asset(s) in satisfaction of the credit. In some embodiments, the secured digital asset deposit account contributes digital assets stored therein in satisfaction of one or more credits on a periodic basis such that the limited digital asset account holds a credit balance until the credit(s) has been satisfied.

Indeed, just mentioned, a secured digital asset deposit account can be linked to a limited digital asset deposit account to set a threshold transmission limit for the limited digital asset account. As used herein, the term “threshold transmission limit” refers to a limit on the transfers that can involve a digital asset account, such as a limited digital asset account. In particular, in some cases, a threshold transmission limit includes a limit on the transfers that can involve a digital asset account as the source account (e.g., the account providing one or more digital assets to be transferred). In some cases, a threshold transmission limit includes a limit on the number of transfers that can involve the digital asset account or the amount of digital assets that can be used by the digital asset account. For instance, in some cases, a limited digital asset deposit account is limited to use the amount of digital assets that are stored in a secured digital asset deposit account that is linked to the limited digital asset account.

As used herein, the term “consolidated digital asset account” (or “consolidated account”) includes a digital asset account that represents or is otherwise associated with multiple underlying digital asset accounts. In particular, a consolidated account can include a digital asset account that includes a combination of features and/or data of multiple underlying digital asset accounts. Indeed, in some instances, a consolidated account is an umbrella account for multiple underlying digital asset accounts. In some cases, the consolidated account consolidates the data and/or features of the underlying digital asset accounts by including curated data and/or features from the underlying digital asset accounts. In some implementations, a consolidated account is a pseudo account in that the consolidated account is not a full-fledge digital asset account that stores and/or uses digital assets but is presented to a client device as such based on the underlying digital asset accounts of the client device. Relatedly, as used herein, the term “consolidated account type” includes a type of digital asset account that corresponds to consolidated accounts. In other words, a consolidated account type can refer to a type of digital asset account that represents or is otherwise associated with multiple underlying digital asset accounts.

Additionally, as used herein, the term “consolidated account structure” refers to the structure of a consolidated digital asset account. In particular, a consolidated account structure refers to the structure of data and/or features associated with a consolidated digital asset account. Indeed, a consolidated account structure can include the data and/or features that have been combined from the multiple underlying digital asset accounts. In one or more embodiments, a consolidated account structure is the representation of the consolidated digital asset account. Indeed, a consolidated account structure can be presented to a client device as a representation of the corresponding consolidated digital asset account. Thus, in some cases, the terms “consolidated digital asset account” and “consolidated account structure” are used interchangeably herein. Relatedly, as used herein, the term “deterministic consolidated account structure” refers to a consolidated account structure that is deterministic in that the consolidated account structure has a deterministic identity. Indeed, as will be discussed below, one or more embodiments of the device account consolidation system 100 generate an account identifier for a consolidated account structure using a deterministic process.

As used herein, the term “account identifier” refers to an identifier for a digital asset account. In particular, an account identifier can refer to an identifier that uniquely identifies a digital asset account within a digital system. For instance, in some cases, an account identifier includes a string of letters, numbers, and/or other symbols that identify a digital asset account. In some cases, an account identifier includes an identifier that is only used internally within the digital system to identify the digital asset account. In some instances, however, an account identifier includes an identifier that is used externally for identifying the digital asset account (e.g., an account number in combination with a routing number or other institutional identifier for the digital system). Relatedly, as used herein, the term “deterministic account identifier” includes an account identifier generated via a deterministic process. Indeed, as will be discussed below, in some cases, the device account consolidation system 100 generates an account identifier for certain digital asset accounts—such as a consolidated digital asset account (e.g., a deterministic consolidated account structure)—using a deterministic process.

Additionally, as used herein, the term “client identifier” refers to an identifier for a client device. In particular, an account identifier can refer to an identifier that uniquely identifies a client device within a digital system. For instance, in some cases, a client identifier includes a string of letters, numbers, and/or other symbols that identify a client device. In some instances, a client identifier is associated with multiple digital asset accounts (e.g., the client device owns, uses and/or manages multiple digital asset accounts).

As used herein, the term “digital asset value” refers to an amount of digital assets of a digital asset account. For instance, a digital asset value can refer to an amount of digital assets stored by a digital asset account. In some cases, a digital asset value refers to an amount of digital assets available for use via a digital asset account. To illustrate, in some cases, a limited digital asset account commits one or more digital assets stored in a secured digital asset deposit account to a transfer, but the secured digital asset deposit account does not transfer the digital asset(s) until after a time period has lapsed. Thus, in some cases, the digital asset value of the limited digital asset account (e.g., the secured digital asset deposit account) includes the amount of digital assets in the secured digital asset deposit account that are still available as they have not yet been committed.

Relatedly, as used herein, the term “consolidated digital asset value” includes a digital asset value of a consolidated digital asset account (e.g., a deterministic consolidated account structure). In particular, a consolidated digital asset value can refer to the amount of digital assets associated with a consolidated digital asset account. To illustrate, in some cases, a consolidated digital asset value includes the combined amount of digital assets stored in or otherwise available via multiple underlying digital asset accounts.

Further, as used herein, the term “client-to-accounts mapping” refers to a mapping of client devices to corresponding digital asset accounts. In particular, a client-to-accounts-mapping can refer to a mapping of a client device to one or more digital asset accounts owned by, used by, and/or managed by the client device. To illustrate, in some cases, a client-to-accounts mapping maps the client identifiers of client devices to corresponding digital asset accounts (e.g., their account identifiers).

As used herein, the term “account data” refers to data associated with a digital asset account. In particular, account data can refer to data associated with the creation, maintenance, support, and/or use of a digital asset account. For instance, account data can include, but is not limited to, the client device associated with a digital asset account (e.g., the client identifier of the client device), transfer information of transfers involving the digital asset account, the digital asset value of the digital asset account, the creation date of the digital asset account, the institution that supports or is otherwise associated with the digital asset account, or an account number or other account identifier of the digital asset account.

Additionally, as used herein, the term “account feature” includes a feature of a digital asset account or data associated with a digital asset account. Indeed, account features of a digital asset account can include account data of the digital asset account but also include additional features. For instance, an account feature of a digital asset account can refer to an available use of a digital asset account or potential interactivity of the digital asset account. For instance, an account feature can include a feature for viewing account data. In some cases, an account feature can include a feature for selecting the particular account data to view (e.g., a feature for searching for account data or filtering retrieved account data). As another example, an account feature can include a feature for involving the digital asset account in a transfer, such as selecting the digital asset account as a source account or a destination account in a transfer. In some instances, an account feature includes the one or more digital assets of the digital asset account available for use. Further, in some implementations, an account feature includes a configuration of a digital asset account (e.g., one or more preferences set by the client device).

As used herein, the term “transfer” refers to a movement of digital assets. In particular, a transfer can refer to a movement of one or more digital assets between digital asset accounts. To illustrate, a transfer can refer to a movement of one or more digital assets from one digital asset account to another digital asset account. As an example, a transfer can include a deposit, a withdrawal, or a sweeping transfer. Relatedly, as used herein, the term “source account” refers to a digital asset account providing one or more digital assets to be transferred, and the term “destination account” refers to a digital asset account receiving one or more digital assets via a transfer. In some cases, a transfer occurs between digital asset accounts associated with (e.g., owned or managed by) the same client device. In some instances, a transfer occurs between a digital asset account of one client device and another digital asset account of another client device.

Additionally, as used herein, the term “sweeping transfer” refers to an automated transfer of one or more digital assets between digital asset accounts of the same client device. In particular, a sweeping transfer can refer to a transfer that is executed in accordance with one or more pre-designated rules rather than in response to another trigger (e.g., a manual trigger provided by a client device for the purpose of causing the transfer). For instance, as will be discussed in more detail below, the device account consolidation system 100 can execute a sweeping transfer in accordance with one or more automatic account sweeping protocols. In some cases, the device account consolidation system 100 executes one or more sweeping transfers in support of another transfer, such as a deposit or withdrawal.

As used herein, the term “automatic account sweeping protocol” refers to one or more pre-designated rules for executing a sweeping transfer. In particular, an automatic account sweeping protocol can refer to one or more pre-designated rules for transferring digital assets between digital asset accounts of a client device via a sweeping transfer. For example, an automatic account sweeping protocol can establish when a sweeping transfer is triggered, how many digital assets are transferred, and which accounts are involved in the transfer. In some cases, an automatic account sweeping protocol is not configurable by the client device. In other words, the automatic account sweeping protocol is defined by the digital system maintaining the digital asset accounts of the client device. As will be discussed in more detail below, in some instances, the device account consolidation system 100 implements one or more automatic account sweeping protocols to support a consolidated digital asset account (e.g., a deterministic consolidated account structure).

Additionally, as used herein, the term “atomic transfer” refers to a transfer of one or more digital assets in which the digital asset(s) becomes inaccessible until the transfer is complete. As will be discussed, the device account consolidation system 100 can prevent one or more digital assets that have been committed to a first transfer from being committed to a second transfer until an atomic transfer that involves the first transfer is complete and the one or more digital assets have been settled into the destination account. Indeed, in some cases, an atomic transfer involves one or more underlying transfers. For instance, an atomic transfer can include a first transfer between a digital asset account of a client device and a third-party digital asset account and a second, sweeping transfer between digital asset accounts of the client device.

Further, as used herein, the term “transfer information” refers to information about a transfer. In particular, transfer information can refer to information regarding the execution of a transfer. For instance, transfer information can include, but is not limited to, the digital asset accounts involved in a transfer, the source account and the destination account, the amount of digital assets transferred, the date and/or time of the transfer, and/or the entities associated with the involved digital asset accounts. Relatedly, as used herein, the term “transfer database” refers to a database storing transfer information.

As used herein, the term “consolidated digital report” refers to a digital report regarding information of a consolidated digital asset account (e.g., a deterministic consolidated account structure). For instance, a consolidated digital report can include, but is not limited, transfer information related to a consolidated digital asset account or a consolidated digital asset value for the consolidated digital asset account. Relatedly, as used herein, the term “filtered consolidated digital report” refers to a consolidated digital report that results after applying a filter (e.g., in response to user input received via a client device) to information.

Further, as used herein, the term “client data” refers to data associated with a client device. In particular, client data can refer to data associated with a client device that owns, uses, and/or manages one or more digital asset accounts. For instance, client data can include a client identifier for the client device and/or digital asset accounts associated with the client device.

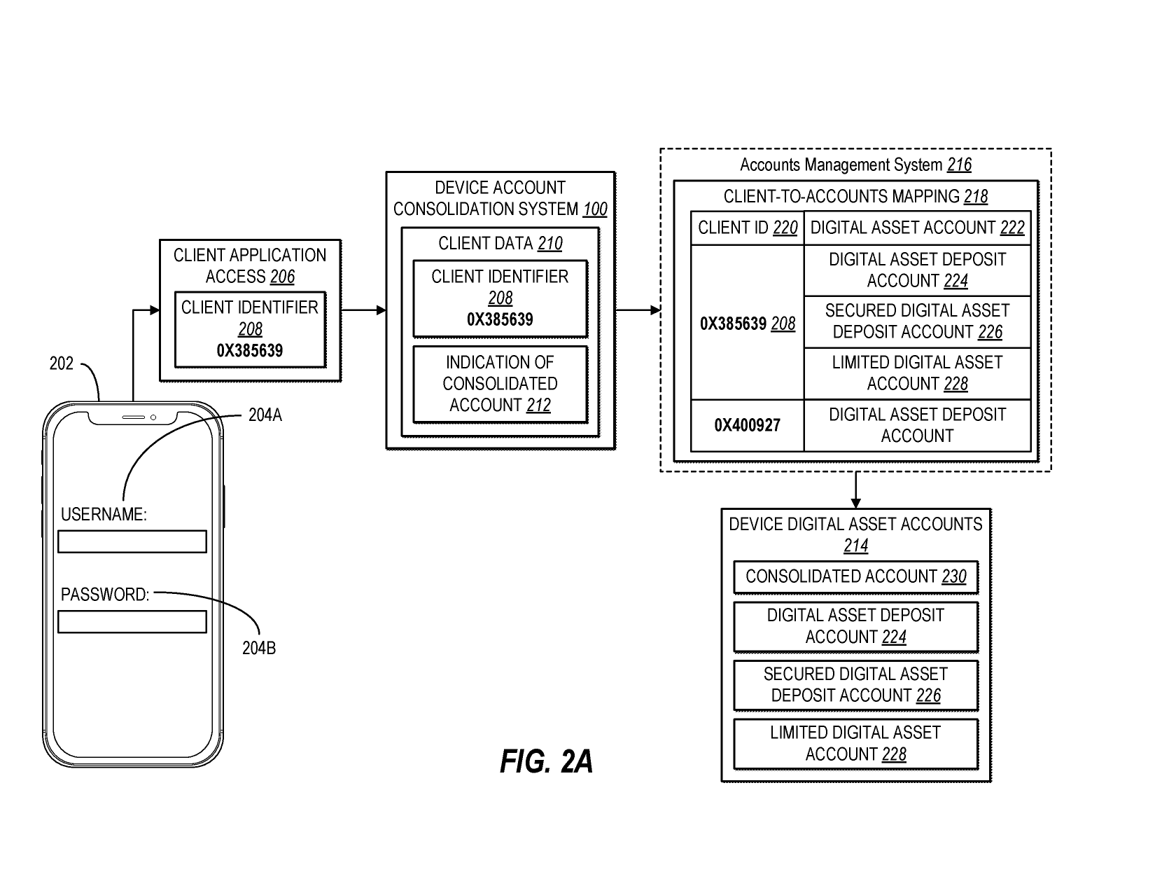

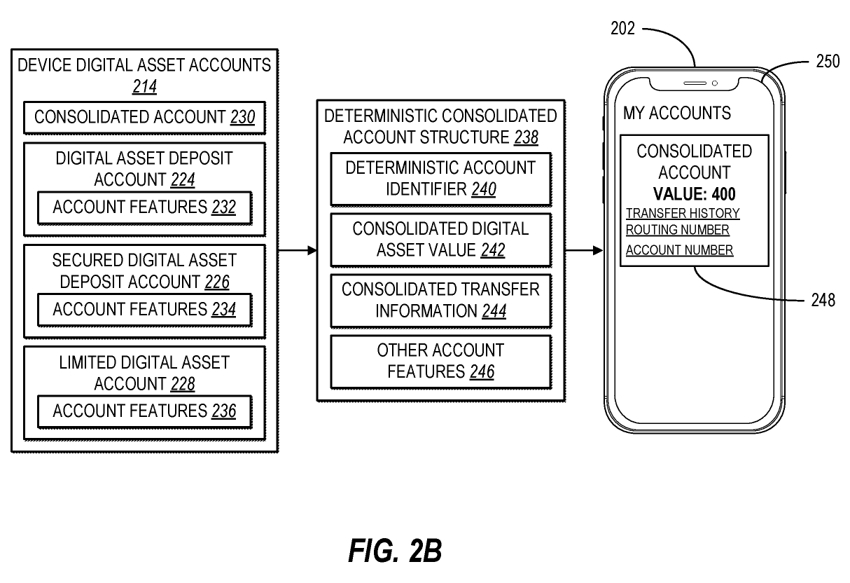

As previously mentioned, in one or more embodiments, the device account consolidation system 100 generates a pseudo account (e.g., a consolidated digital asset account) for a client device based on a collection of underlying digital asset accounts of the client device. In particular, the device account consolidation system 100 generates a deterministic consolidated account structure that consolidates features of the collection of underlying digital asset accounts. FIGS. 2A-2B illustrate the device account consolidation system 100 generating a deterministic consolidated account structure for a client device in accordance with one or more embodiments.

As shown in FIG. 2A, the device account consolidation system 100 detects a client device 202 accessing a client application for managing digital asset accounts (as indicated by the username field 204a and the password field 204b). For instance, the device account consolidation system 100 can detect the client device 202 accessing a digital system for managing digital asset accounts via the client application. As indicated, the device account consolidation system 100 receives, as part of the client application access 206, a client identifier 208 for the client device 202. In some cases, the device account consolidation system 100 receives the client identifier 208 directly from the client device 202. In some instances, however, the device account consolidation system 100 determines the client identifier 208 upon receiving the login credentials from the client device 202. For instance, the device account consolidation system 100 can maintain a mapping between the client device (e.g., the login credentials of the client device) and information for the client device and identifies the client identifier 208 from this information.

Indeed, as shown in FIG. 2A, the device account consolidation system 100 maintains client data 210 for the client device 202, which includes the client identifier 208. Thus, the device account consolidation system 100 can extract the client identifier 208 from the client data 210. As further shown, the client data 210 also includes an indication 212 of a consolidated account for the client device 202. Indeed, the client data 210 can indicate that the client device 202 has opted in to using a consolidated account. Thus, in some cases, the device account consolidation system 100 also extracts the indication 212 from the client data 210.

As illustrated, the device account consolidation system 100 determines digital asset accounts 214 that are associated with the client device 202. In particular, as illustrated, the device account consolidation system 100 uses an accounts management system 216 to determine the digital asset accounts 214 of the client device 202.

Indeed, in one or more embodiments, the device account consolidation system 100 implements or uses various sub-systems in creating and/or managing digital asset accounts of client devices. For instance, the device account consolidation system 100 can implement or use each sub-system to perform a particular set of functions in creating and/or managing digital asset accounts. For instance, the device account consolidation system 100 can use the accounts management system 216 to perform functions related to the tracking of digital asset accounts associated with a client device. As another example, the device account consolidation system 100 can use a transfer management system to manage transfers involving the digital asset accounts of a client device (e.g., to execute transfers and/or maintain transfer information related to the transfers). Thus, in some cases, the device account consolidation system 100 communicates with these various sub-systems internally to perform their functions as needed.

For instance, in some cases, the device account consolidation system 100 requests that the accounts management system 216 return the digital asset accounts that are associated with the client device 202 and provides the client identifier 208 and the indication 212 that the client device 202 has opted in to using a consolidated account as part of the request. In some instances, however, the device account consolidation system 100 uses the accounts management system 216 to store the indication 212 and map the indication 212 to the client device 202. Thus, the device account consolidation system 100 can determine that the client device 202 has opted into a consolidated account via the accounts management system 216 and based on the client identifier 208.

As illustrated in FIG. 2A, via the accounts management system 216, the device account consolidation system 100 uses a client-to-accounts mapping 218 to determine the digital asset accounts 214 that are associated with the client device 202. Indeed, FIG. 2A illustrates the client-to-accounts mapping 218 mapping client identifiers (e.g., via the column 220) to digital asset accounts (e.g., via the column 222). In some cases, the client-to-accounts mapping 218 maps the client identifiers to the corresponding account identifiers. Thus, via the accounts management system 216, the device account consolidation system 100 can identify the client identifier 208 of the client device 202 within the client-to-accounts mapping 218 and further determine the digital asset accounts 214 associated with the client identifier 208. In particular, as shown in FIG. 2A, the device account consolidation system 100 uses the client-to-accounts mapping 218 to determine that the client identifier 208 is associated with a digital asset deposit account 224, a secured digital asset deposit account 226, and a limited digital asset account 228.

As further illustrated by FIG. 2A, via the accounts management system 216, the device account consolidation system 100 further determines that a consolidated account 230 (e.g., a deterministic consolidated account structure) is associated with the client device 202. As indicated, however, the consolidated account 230 is not mapped to the client identifier 208 of the client device 202 within the client-to-accounts mapping 218. Indeed, in some cases, the device account consolidation system 100 does not store the consolidated account 230 within the client-to-accounts mapping 218. Moreover, in some instances, the device account consolidation system 100 does not store the consolidated account 230 within storage at all. Rather, as will be discussed, the device account consolidation system 100 can create the consolidated account 230 (e.g., creates the deterministic consolidated account structure) on the fly. For instance, the device account consolidation system 100 can create the consolidated account 230 upon determining that the client device 202 has opted in to having a consolidated account (e.g., via the indication 212). More specifically, the device account consolidation system 100 can create the consolidated account 230 in response to the client device 202 accessing the client application (e.g., accessing the digital system) based on the indication 212. In some cases, however, the device account consolidation system 100 does store the consolidated account 230 and retrieves the consolidated account 230 from the client-to-accounts mapping 218 when needed.

As illustrated in FIG. 2B, the digital asset deposit account 224 includes account features 232, the secured digital asset deposit account 226 also includes account features 234, and the limited digital asset account 228 also includes account features 236. In some cases, the device account consolidation system 100 determines the account features for each digital asset account upon determining that the digital asset account is associated with the client device 202 (e.g., via the accounts management system 216).

As further illustrated, the device account consolidation system 100 generates a deterministic consolidated account structure 238 for the consolidated account 230. Indeed, upon determining (e.g., via the accounts management system 216) that the client device 202 is associated with the consolidated account 230, the device account consolidation system 100 can generate the deterministic consolidated account structure 238.

For instance, as shown in FIG. 2B, the device account consolidation system 100 generates the deterministic consolidated account structure 238 by generating or incorporating various account features for the deterministic consolidated account structure 238. In some cases, the device account consolidation system 100 generates the deterministic consolidated account structure 238 using the account features of the underlying digital asset accounts (e.g., the account features of the digital asset deposit account 224, the secured digital asset deposit account 226, and/or the limited digital asset account 228). For example, the device account consolidation system 100 can create an account feature for the deterministic consolidated account structure 238 using a combination of account features from multiple underlying digital asset accounts. In some instances, the device account consolidation system 100 extracts an account feature from one of the underlying digital asset accounts for use as an account feature of the deterministic consolidated account structure 238. In some cases, the device account consolidation system 100 further creates one or more account features for the deterministic consolidated account structure 238 using the client data 210 of the client device 202.

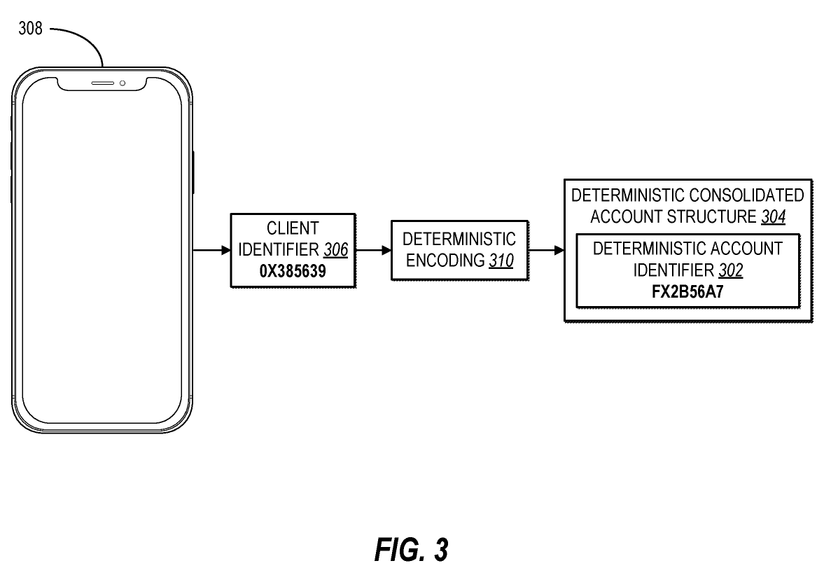

To illustrate, FIG. 2B shows the device account consolidation system 100 generating a deterministic account identifier 240, a consolidated digital asset value 242, and consolidated transfer information 244 for the deterministic consolidated account structure 238. The creation of these account features will be discussed more below with reference to FIGS. 3-5C.

FIG. 2B further shows the device account consolidation system 100 incorporating other account features 246 as part of the deterministic consolidated account structure 238. For example, in some embodiments, the device account consolidation system 100 includes an account number or information regarding an institution that supports or is otherwise associated with an underlying digital asset account as an account feature for the deterministic consolidated account structure 238.

As further shown in FIG. 2B, the device account consolidation system 100 provides the deterministic consolidated account structure 238 (e.g., the consolidated account 230) to the client device. In particular, the device account consolidation system 100 provides a graphical representation 248 of the deterministic consolidated account structure 238 for display within a graphical user interface 250 of the client device 202. As indicated, the graphical representation 248 displays various account features for the deterministic consolidated account structure 238. In some embodiments, the graphical representation 248 includes (or the graphical user interface 250 otherwise includes) one or more interactive elements, and the device account consolidation system 100 causes the graphical user interface 250 to display additional account features upon detecting user interactions with the interactive elements.

As indicated by FIG. 2B, the device account consolidation system 100 causes the graphical user interface 250 to display the deterministic consolidated account structure 238 (i.e., the graphical representation 248) without displaying the underlying digital asset accounts. Indeed, in some cases, the device account consolidation system 100 hides the underlying digital asset accounts from view (including the account features that were not incorporated within the deterministic consolidated account structure 238). Thus, the device account consolidation system 100 causes the graphical user interface 250 to display a graphical representation of a single digital asset account (i.e., the deterministic consolidated account structure 238) that represents the underlying collection of digital asset accounts.

Thus, in some cases, upon detecting that the client device 202 has accessed the client application for managing digital asset accounts (e.g., has accessed the digital system), the device account consolidation system 100 causes the client device 202 to display the graphical representation 248 rather than the underlying digital asset accounts. As such, the device account consolidation system 100 incorporates and presents relevant account features within a unified structure, enabling the client device 202 to manage the collection of underlying accounts (including the digital assets stored therein) as if they were a single account.

As mentioned, in one or more embodiments, the device account consolidation system 100 generates various account features for a deterministic consolidated account structure for a client device that has opted in to a consolidated account that represents a collection of underlying digital asset accounts. For example, in certain implementations, the device account consolidation system 100 generates a deterministic account identifier for a deterministic consolidated account structure. FIG. 3 illustrates the device account consolidation system 100 generating a deterministic account identifier in accordance with one or more embodiments.

As shown in FIG. 3, the device account consolidation system 100 generates a deterministic account identifier 302 for a deterministic consolidated account structure 304 using a client identifier 306 of the client device 308 that has opted into the consolidated account. Further, the device account consolidation system 100 encodes the client identifier 306. For instance, as indicated, the device account consolidation system 100 encodes the client identifier 306 using a deterministic encoding 310.

Indeed, as previously mentioned, the device account consolidation system 100 can generate the deterministic consolidated account structure 304 on the fly. For instance, the device account consolidation system 100 can generate the deterministic consolidated account structure 304 in response to the client device 308 accessing the digital system maintaining its digital asset accounts (e.g., accessing a client application corresponding to the digital system). Thus, in some implementations, the device account consolidation system 100 generates the deterministic consolidated account structure 304—including the deterministic account identifier 302—anew each time the client device 308 accesses the digital system. As such, the device account consolidation system 100 can use a deterministic process to ensure the deterministic account identifier 302 is consistent across access events.

To illustrate, in one or more embodiments, the device account consolidation system 100 generates the deterministic account identifier 302 by encoding the client identifier 208 into a hexadecimal format or other format that can be deterministically determined. In some cases, the device account consolidation system 100 adds a prefix or a suffix to the client identifier 306 before or after it has been encoded. In some embodiments, the device account consolidation system 100 generates a checksum of the client identifier 306. Indeed, various implementations of the device account consolidation system 100 use various methods deterministic encoding.

In some implementations, the deterministic account identifier 302 identifies the deterministic consolidated account structure 304 as a consolidated account type. Indeed, the device account consolidation system 100 can generate the deterministic account identifier 302 in a format that indicates the identifier is associated with a deterministic consolidated account structure rather than a different type of digital asset account (e.g., a digital asset deposit account, a secured digital asset deposit account, or a limited digital asset account). Thus, in some cases, the device account consolidation system 100 uses the deterministic account identifier 302 internally (e.g., as it implements its various sub-systems) to ensure that its operations facilitate the use and presentation of the deterministic consolidated account structure 304 as a single account representing a collection of underlying digital asset accounts.

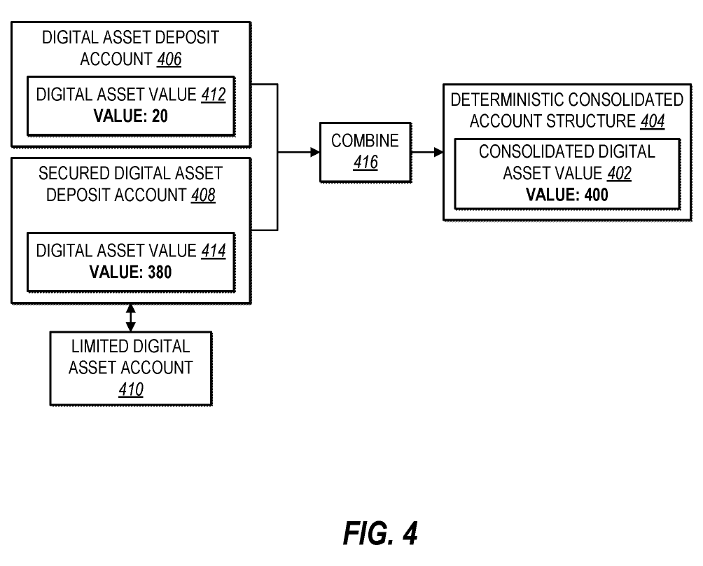

As further mentioned, in one or more embodiments, the device account consolidation system 100 generates a consolidated digital asset value for a deterministic consolidated account structure of a client device. FIG. 4 illustrates the device account consolidation system 100 generating a consolidated digital asset value in accordance with one or more embodiments.

Indeed, as shown in FIG. 4, the device account consolidation system 100 generates a consolidated digital asset value 402 for a deterministic consolidated account structure 404 using the digital asset values of multiple of the underlying digital asset accounts. In some cases, the device account consolidation system 100 uses the digital asset values of all underlying digital asset accounts of a client device. In some instances, however, the device account consolidation system 100 uses a subset of the underlying digital asset accounts. For instance, FIG. 4 illustrates a collection of digital asset accounts of a client device including a digital asset deposit account 406, a secured digital asset deposit account 408, and a limited digital asset deposit account 410. As further shown, the device account consolidation system 100 uses the digital asset value 412 of the digital asset deposit account 406 and the digital asset value 414 of the secured digital asset deposit account 408 to generate the consolidated digital asset value 402.

Indeed, as indicated by FIG. 4, the secured digital asset deposit account 408 and the limited digital asset deposit account 410 are linked. For instance, in some embodiments, the secured digital asset deposit account 408 sets a threshold transmission limit for the limited digital asset deposit account 410. In particular, the digital asset value 414 of the secured digital asset deposit account 408 sets the threshold transmission limit for the limited digital asset deposit account 410. Thus, in some cases, the digital asset value of the limited digital asset deposit account 410 is tied to the digital asset value 414 of the secured digital asset deposit account 408. In some cases, the digital asset value 414 of the secured digital asset deposit account 408 includes the amount of digital assets stored in the secured digital asset deposit account 408. In some instances, the digital asset value 414 includes the amount of digital assets that are available for use (e.g., the amount of digital assets stored less the amount of digital assets that have already been committed for transfer).

As shown in FIG. 4, the device account consolidation system 100 generates the consolidated digital asset value 402 by performing an act 416 for combining the digital asset value 412 of the digital asset deposit account 406 and the digital asset value 414 of the secured digital asset deposit account 408. For instance, the device account consolidation system 100 can add the digital asset value 412 and the digital asset value 414 together. Thus, in some cases, the consolidated digital asset value 402 represents a total amount of digital assets that are available for user across the collection of underlying digital asset accounts. As such, the device account consolidation system 100 can use the consolidated digital asset value 402 to facilitate the use and presentation of the deterministic consolidated account structure 404 as a single account having a single digital asset value.

In one or more embodiments, the device account consolidation system 100 uses the consolidated digital asset value 402 as a consolidated digital report for the deterministic consolidated account structure 404. For instance, the device account consolidation system 100 can treat the corresponding client device accessing the digital system as a query for information for the collection of underlying digital asset accounts. As mentioned, the device account consolidation system 100 can generate the deterministic consolidated account structure 404 in response to the client device accessing the digital system. The device account consolidation system 100 can further generate and provide (e.g., for display via the graphical user interface of the client device) the consolidated digital asset value 402 as a consolidated digital report for the deterministic consolidated account structure 404.

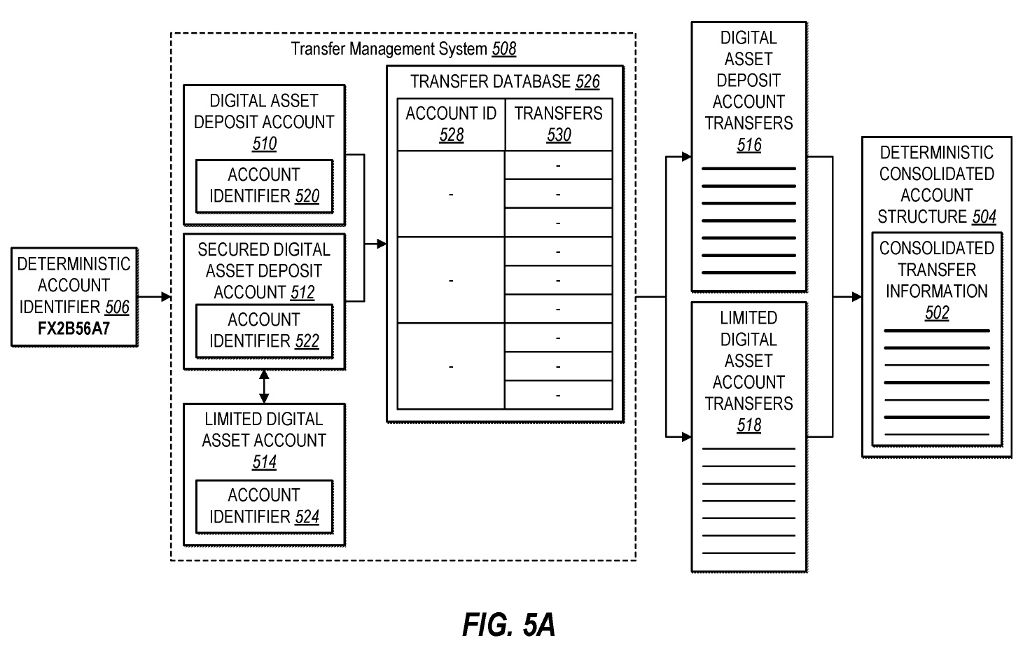

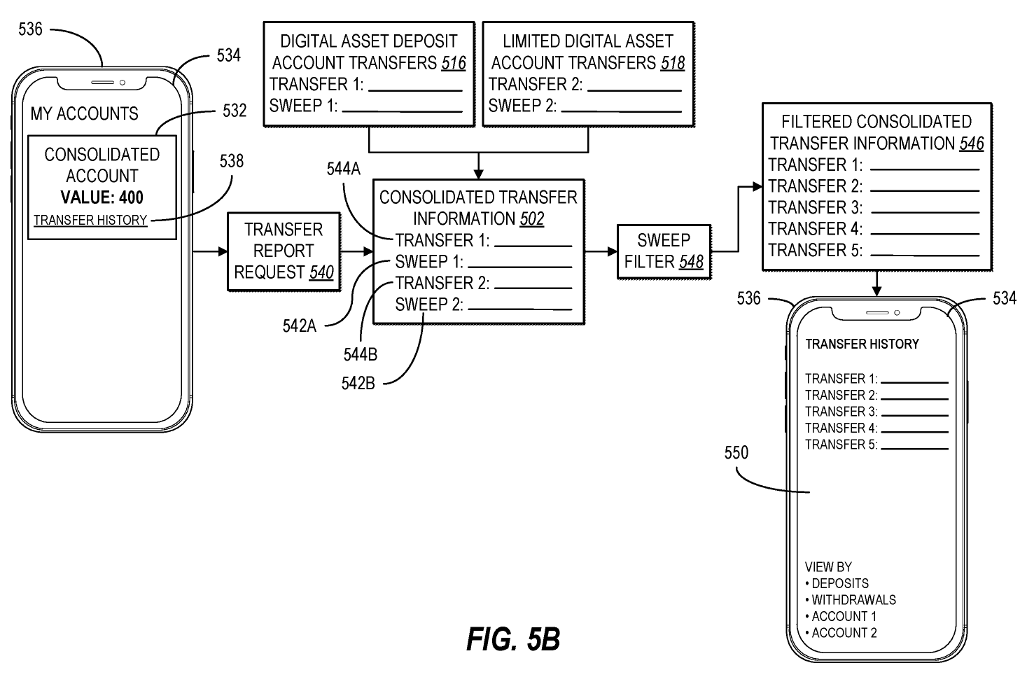

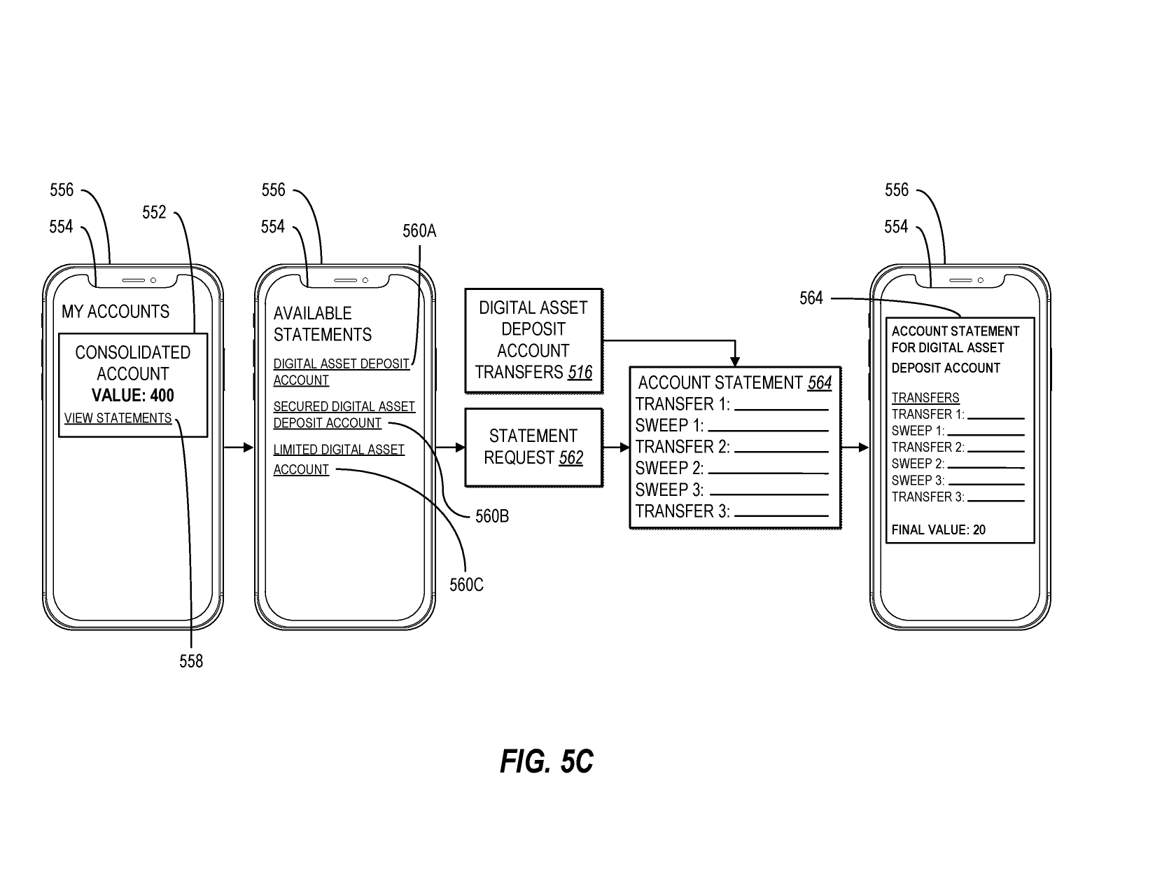

As further mentioned, in one or more embodiments, the device account consolidation system 100 generates consolidated transfer information for a deterministic consolidated account structure of a client device. For instance, the device account consolidation system 100 can generate consolidated transfer information for inclusion within a consolidated digital report. FIG. 5A illustrates the device account consolidation system 100 generating consolidated transfer information in accordance with one or more embodiments. FIGS. 5B-5C illustrate the device account consolidation system 100 using transfer information associated with a deterministic consolidated account structure in accordance with one or more embodiments.

As indicated in FIG. 5A, the device account consolidation system 100 generates consolidated transfer information 502 for a deterministic consolidated account structure 504 of a client device using a deterministic account identifier 506 generated for the deterministic consolidated account structure 504. For instance, as shown, the device account consolidation system 100 provides the deterministic account identifier 506 to a transfer management system 508. In some cases, the device account consolidation system 100 provides the deterministic account identifier 506 as part of a request or trigger for retrieving transfer information for the deterministic consolidated account structure 504.

As previously mentioned, the deterministic account identifier 506 can identify the deterministic consolidated account structure 504 as a consolidated account type. Thus, the device account consolidation system 100 can use the deterministic account identifier 506 to enable the transfer management system 508 to retrieve transfer information for a consolidated account type rather than for a different type of digital asset account. For instance, in some cases, based on the deterministic account identifier 506, the device account consolidation system 100 uses the transfer management system 508 to retrieve transfer information for one or more of the underlying digital asset accounts.

Indeed, as shown in FIG. 5A, via the transfer management system 508, the device account consolidation system 100 retrieves transfer information for the digital asset accounts represented by the deterministic consolidated account structure 504. In particular, FIG. 5A illustrates a digital asset deposit account 510, a secured digital asset deposit account 512, and a limited digital asset account 514 that is linked to the secured digital asset deposit account 512. Further, FIG. 5A illustrates the device account consolidation system 100 using the transfer management system 508 to retrieve transfer information 516 for the digital asset deposit account 510 and transfer information 518 for the limited digital asset account 514. In some cases, as the limited digital asset account 514 and the secured digital asset deposit account 512 are linked, the device account consolidation system 100 retrieves the transfer information 516 for the limited digital asset account 514 but does not retrieve separate transfer information for the secured digital asset deposit account 512. In some cases, the device account consolidation system 100 does retrieve separate transfer information for the secured digital asset deposit account 512. In some embodiments, the transfer information 516 for the limited digital asset account 514 already includes transfer information for the secured digital asset deposit account 512 (e.g., deposits into the secured digital asset deposit account 512) based on the link between the two accounts.

As indicated by FIG. 5A, via the transfer management system 508, the device account consolidation system 100 retrieves the transfer information 516 and the transfer information 518 using the account identifiers for their respective digital asset accounts. Indeed, as shown, the digital asset deposit account 510 includes an account identifier 520, the secured digital asset deposit account 512 includes an account identifier 522, and the limited digital asset account 514 also includes an account identifier 524. Thus, the device account consolidation system 100 can use the account identifier of a digital asset account to retrieve its corresponding transfer information.

As further indicated by FIG. 5A, via the transfer management system 508, the device account consolidation system 100 retrieves the transfer information 516 and the transfer information 518 by extracting the information from a transfer database 526. Indeed, as illustrated, the transfer database 526 maps account identifiers (e.g., via the column 528) to transfer information (e.g., via the column 530) for the corresponding digital asset account. Thus, via the transfer management system 508, the device account consolidation system 100 can identify the account identifier of a digital asset account within the transfer database 526 and further determine the transfer information associated with the account identifier. In some cases, by extracting the transfer information for a digital asset account, the device account consolidation system 100 determines (or extracts) information for the transfers that involved the digital asset account (which can include information for transfers involving a linked digital asset account).

As illustrated, the device account consolidation system 100 generates the consolidated transfer information 502 for the deterministic consolidated account structure 504 using the transfer information 516 and the transfer information 518. For instance, the device account consolidation system 100 can aggregate the transfer information 516 and the transfer information 518 into a single set of transfer information to create the consolidated transfer information 502. Thus, in some cases, the consolidated transfer information 502 represents information for a single set of transfers. In some cases, the device account consolidation system 100 configures or modifies the consolidated transfer information 502 to appear as involving the deterministic consolidated account structure 504 rather than the underlying digital asset account. For instance, the device account consolidation system 100 can configure or modify the consolidated transfer information 502 to identify the deterministic consolidated account structure 504—rather than the underlying digital asset account—as the source account or destination account of each transfer. As such, the device account consolidation system 100 can use the consolidated transfer information 502 to facilitate the use and presentation of the deterministic consolidated account structure 504 as a single account that manages the digital assets of the client device.

FIG. 5B illustrates the device account consolidation system 100 generating and providing a consolidated digital report for the deterministic consolidated account structure 504 using the consolidated transfer information 502 in accordance with one or more embodiments. In particular, FIG. 5B illustrates the device account consolidation system 100 generating and providing a filtered consolidated digital report derived from the consolidated transfer information 502 in accordance with one or more embodiments. For instance, in some cases, the device account consolidation system 100 generates and provides the filtered consolidated digital report in response to a query for information.

In particular, FIG. 5B illustrates the device account consolidation system 100 providing a graphical representation 532 of the deterministic consolidated account structure 504 for display within a graphical user interface 534 of the client device 536 associated with the deterministic consolidated account structure 504. The device account consolidation system 100 includes, within the graphical user interface 534, an interactive option 538 for requesting a consolidated digital report for the deterministic consolidated account structure 504. In particular, the interactive option 538 includes an option for submitting a query for transfer information for the deterministic consolidated account structure 504. When a user interaction selects the interactive option 538, the device account consolidation system 100 receives a transfer report request 540.

In response to receiving the transfer report request 540, the device account consolidation system 100 creates the consolidated transfer information 502 for the deterministic consolidated account structure 504. In particular, the device account consolidation system 100 creates the deterministic consolidated account structure 504 using the transfer information 516 and the transfer information 518 as discussed above with reference to FIG. 5A. In some embodiments, however, the device account consolidation system 100 creates the consolidated transfer information 502 before receiving such a request. For instance, the device account consolidation system 100 can create the consolidated transfer information 502 when the client device 536 accesses the digital system.

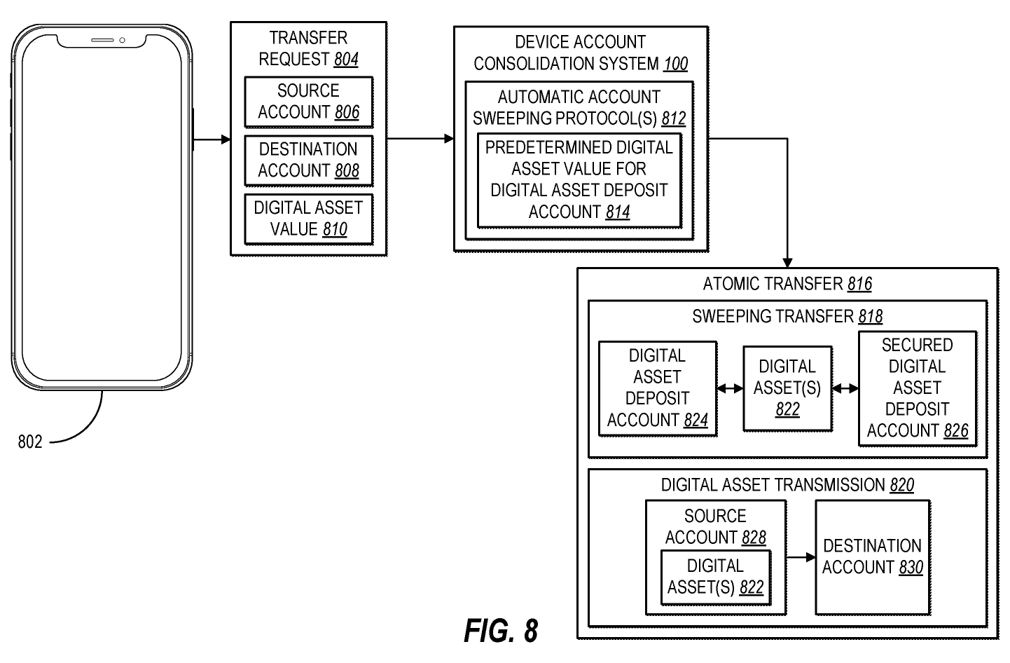

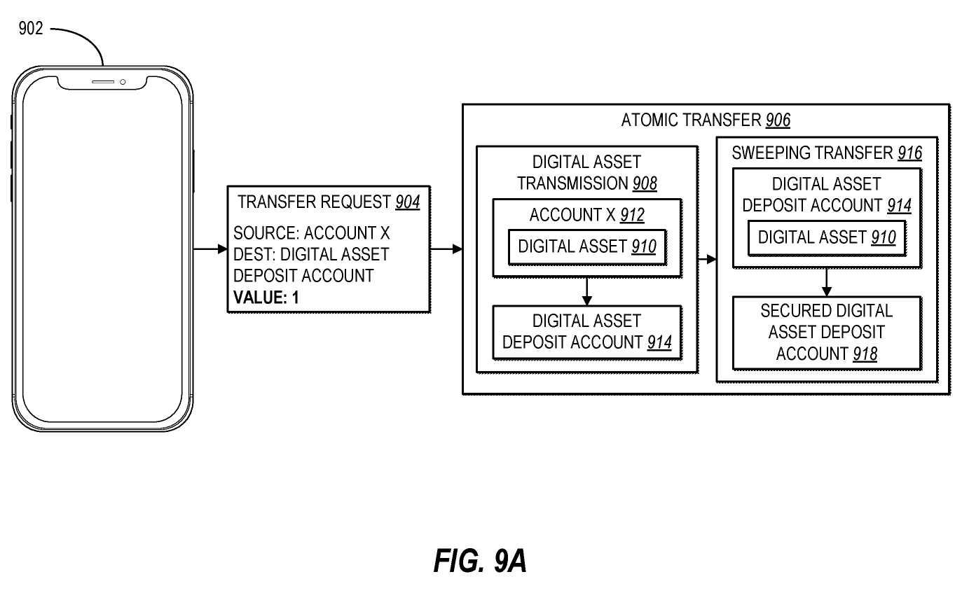

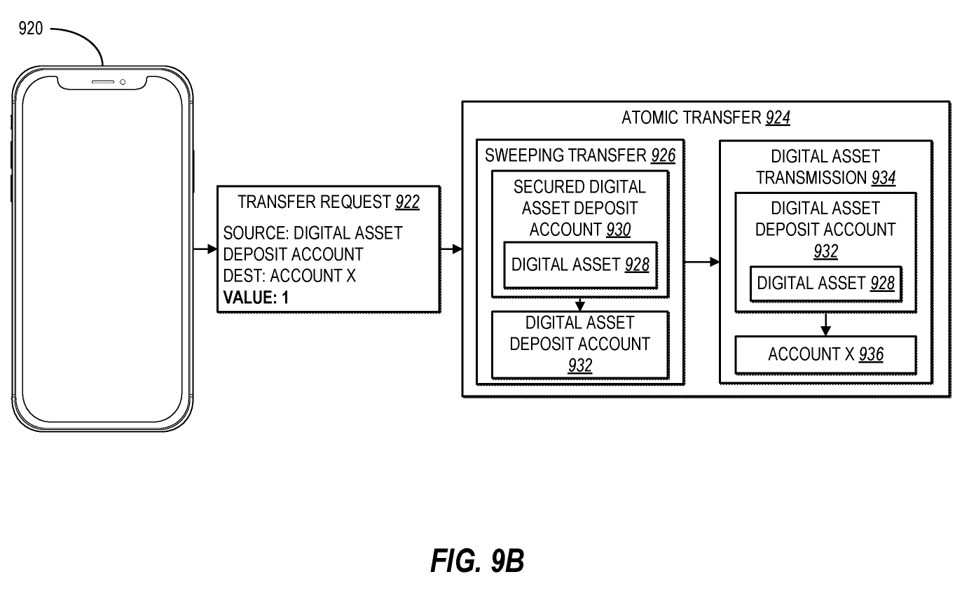

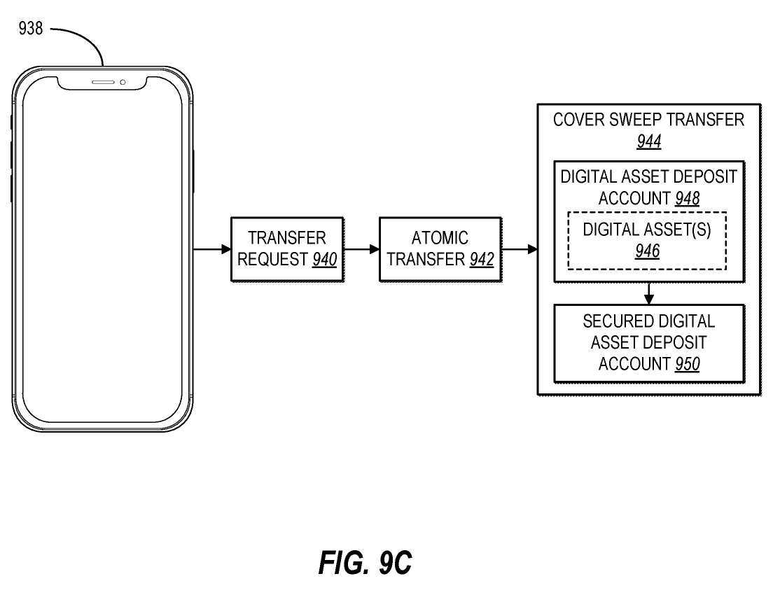

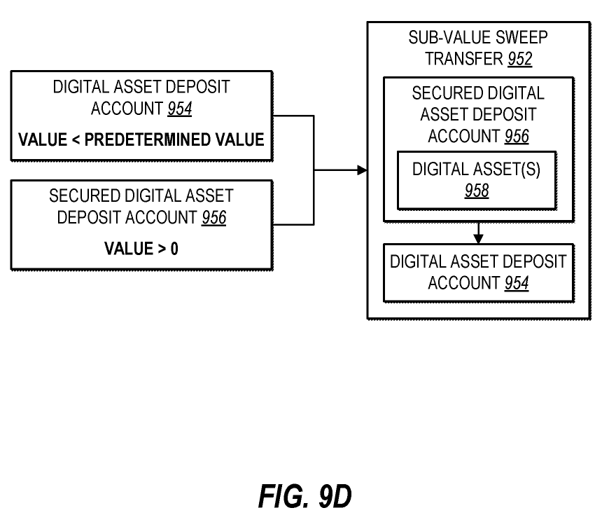

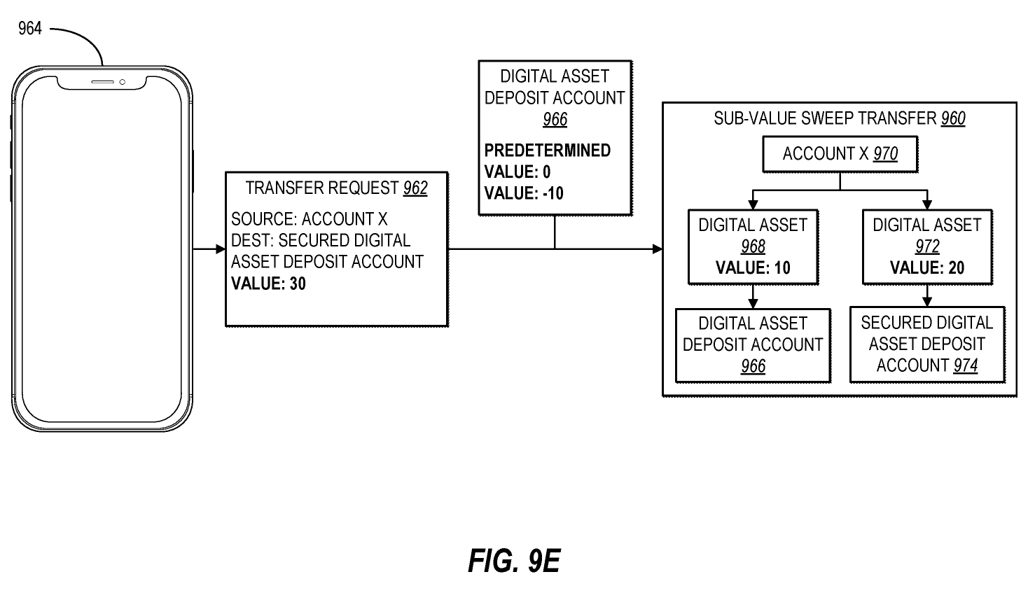

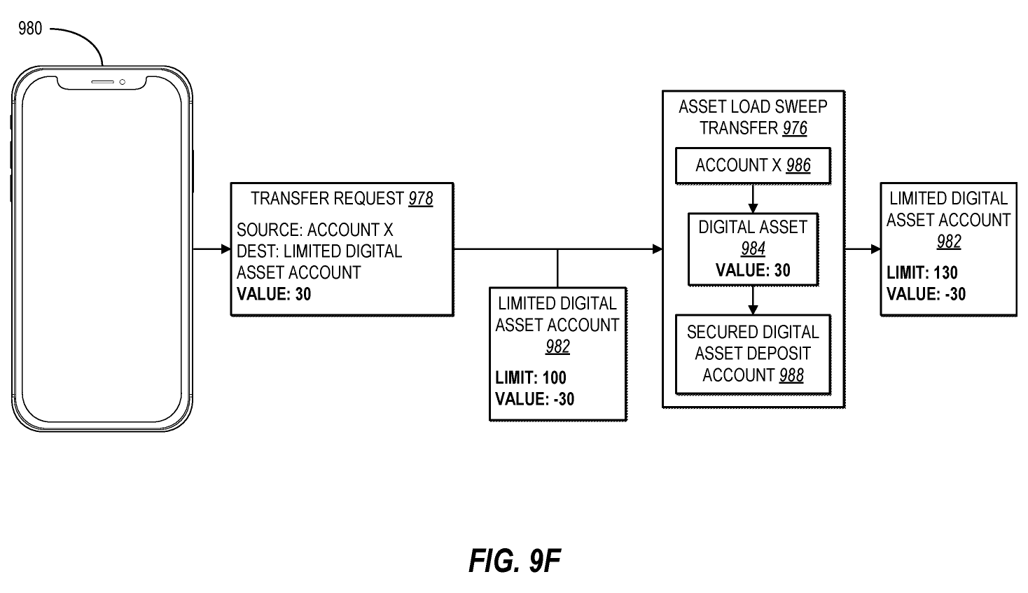

As shown in FIG. 5B, the consolidated transfer information 502 includes information regarding sweeping transfers, such as the first sweeping transfer 542a and the second sweeping transfer 542b. The consolidated transfer information 502 further includes information regarding other transfers (e.g., deposits, withdrawals, or other transfers), such as the first transfer 544a and the second transfer 544b. Indeed, as shown, the transfer information 516 and the transfer information 518 include information regarding various transfers—including sweeping transfers—that involve the corresponding digital asset account. Thus, when creating the consolidated transfer information 502 by aggregating the transfer information 516 and the transfer information 518, the device account consolidation system 100 can include the sweeping transfers. More information regarding the use of sweeping transfers will be provided below with respect to FIGS. 8-9F.

As further shown in FIG. 5B, the device account consolidation system 100 generates filtered consolidated transfer information 546 from the consolidated transfer information 502 using a sweep filter 548. In particular, the device account consolidation system 100 generates the filtered consolidated transfer information 546 by filtering out the sweeping transfers from the consolidated transfer information 502. Thus, the device account consolidation system 100 can create the filtered consolidated transfer information 546 to exclude the sweeping transfers but to include other transfers, such as deposits and withdrawals.

Indeed, as will be explained in more detail below, the device account consolidation system 100 can use sweeping transfers to automatically move digital assets between the digital asset accounts of the client device 536 in accordance with pre-configured protocols. Thus, in some cases, inclusion of the sweeping transfers in the transfer information presented to the client device 536 interferes with the presentation of the deterministic consolidated account structure 504 as a single digital asset account. By excluding the sweeping transfers, the device account consolidation system 100 configures the transfer information presented to the client device 536 to support the presentation of a single digital asset account. Moreover, as previously suggested, the device account consolidation system 100 can modify the information included in the filtered consolidated transfer information 546 to identify the deterministic consolidated account structure 504—rather than the underlying digital asset account—as the source account or destination account of each represented transfer. As such, the device account consolidation system 100 provides the client device 536 with information regarding transfers of digital assets to and from the deterministic consolidated account structure 504, furthering the presentation of the deterministic consolidated account structure 504 as a single digital asset account.

As illustrated, the device account consolidation system 100 generates a filtered consolidated digital report 550 from the filtered consolidated transfer information 546 and provides the filtered consolidated digital report 550 for display within the graphical user interface 534 of the client device 536. Indeed, as shown, the filtered consolidated digital report 550 includes the filtered consolidated transfer information 546 derived from the transfer information 516 for the digital asset deposit account 510 and the transfer information 518 for the limited digital asset account 514 (e.g., derived via the aggregation and filtering).

In one or more embodiments, the device account consolidation system 100 generates and provides the filtered consolidated digital report 550 as part of the graphical representation 532 for the deterministic consolidated account structure 504. For instance, the device account consolidation system 100 can modify the graphical representation 532 within the graphical user interface 534 to display the filtered consolidated digital report 550. In some cases, the device account consolidation system 100 provides the filtered consolidated digital report 550 as part of a separate graphical representation.

As further illustrated, the device account consolidation system 100 provides, within the graphical user interface 534, additional interactive options 552a-552d for further filtering of the filtered consolidated transfer information 546 presented within the filtered consolidated digital report 550. For instance, as shown, the device account consolidation system 100 can provide interactive options for further filtering the information by transfer type or by account. The device account consolidation system 100 can provide interactive options for various filters in various implementations. In one or more embodiments, the device account consolidation system 100 modifies the filtered consolidated digital report 550 within the graphical user interface 534 to present the relevant information (and hide the filtered information) in response to detecting a user interaction with one of the presented interactive options.

Though FIG. 5B illustrates the device account consolidation system 100 providing the filtered consolidated digital report 550 generated from the filtered consolidated transfer information 546, the device account consolidation system 100 can provide a (e.g., non-filtered) consolidated digital report in some cases. For example, in some implementations, the device account consolidation system 100 generates a consolidated digital report from the consolidated transfer information 502 and provides the report to the client device 536 for display.

FIG. 5C illustrates the device account consolidation system 100 generating and providing an account statement for an underlying digital asset account of the deterministic consolidated account structure 504 in accordance with one or more embodiments. Indeed, while the device account consolidation system 100 can generate and provide (filtered) consolidated digital reports that present the deterministic consolidated account structure 504 as a single digital asset account, the device account consolidation system 100 can further generate and provide individual account statements in some implementations. For instance, the device account consolidation system 100 can generate and provide an account statement having transfer information for a digital asset account that underlies the deterministic consolidated account structure 504.

Indeed, FIG. 5C illustrates the device account consolidation system 100 providing a graphical representation 552 of the deterministic consolidated account structure 504 for display within a graphical user interface 554 of the client device 556 associated with the deterministic consolidated account structure 504. The device account consolidation system 100 includes, within the graphical user interface 554, an interactive option 558 for requesting an account statement for one or more of the digital asset accounts underlying the deterministic consolidated account structure 504. When a user interaction selects the interactive option 558, the device account consolidation system 100 modifies the graphical user interface 554 to provide interactive options 560a-560c corresponding to each of the underlying digital asset accounts. In some cases, the device account consolidation system 100 provides the interactive options 560a-560c in conjunction with the graphical representation 552 rather than in a separate presentation.

As illustrated in FIG. 5C, when a user interaction selects one of the interactive options 560a-560c, the device account consolidation system 100 receives a statement request 562. For instance, upon selection of the interactive option 560a corresponding to the digital asset deposit account 510, the device account consolidation system 100 receives a request to for an account statement for the digital asset deposit account 510. As further illustrated, upon receiving the statement request 562, the device account consolidation system 100 retrieves the transfer information 516 for the digital asset deposit account 510. For instance, the device account consolidation system 100 can retrieve the transfer information 516 via the transfer management system 508 as discussed above with reference to FIG. 5A.

As further shown, the device account consolidation system 100 can generate an account statement 564 for the digital asset deposit account 510 from the transfer information 516. Further, the device account consolidation system 100 provides the account statement 564 for display within the graphical user interface 554 of the client device 556. As indicated, the account statement 564 includes the transfer information 516 for the digital asset deposit account 510, including information regarding sweeping transfers involving the digital asset deposit account 510. Additionally, the account statement 564 includes other information, such as the digital asset value of the digital asset deposit account 510 at the end of the time period covered by the account statement 564. Thus, while one or more embodiments of the device account consolidation system 100 aggregate and filter transfer information to provide a presentation of the deterministic consolidated account structure 504 as a single digital asset account, some embodiments of the device account consolidation system 100 can provide information for individual digital asset accounts represented by the deterministic consolidated account structure 504 upon request.

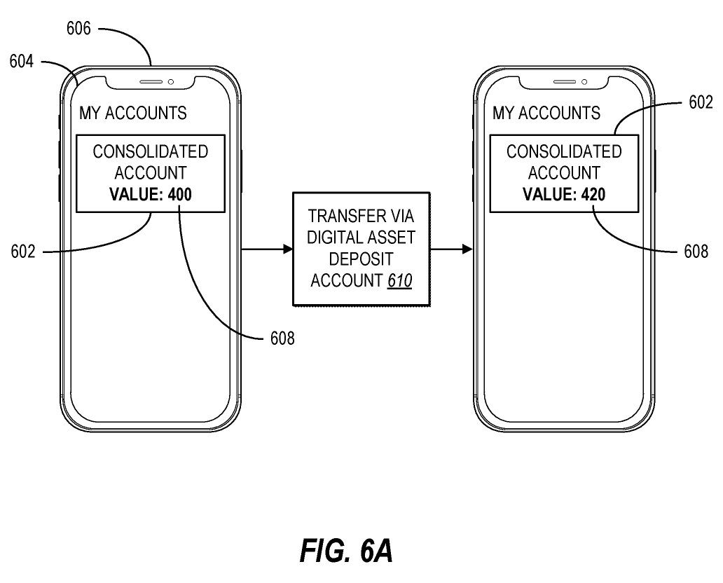

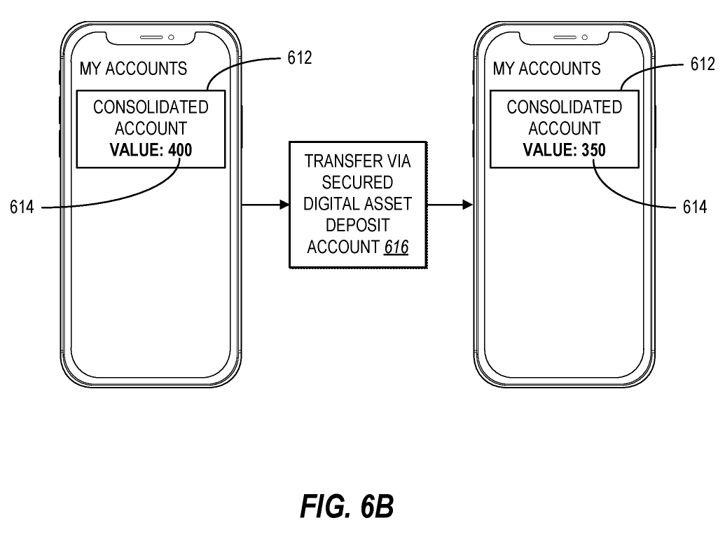

As discussed above, in certain implementations, the device account consolidation system 100 creates and displays a consolidated digital asset value for a deterministic consolidated account structure of a client device. In some cases, the device account consolidation system 100 further modifies the consolidated digital asset value as transfers are executed involving the deterministic consolidated account structure (e.g., involving one of the underlying digital asset accounts). FIGS. 6A-6B illustrate the device account consolidation system 100 modifying a consolidated digital asset value in accordance with one or more embodiments.

For instance, FIG. 6A illustrates the device account consolidation system 100 providing a graphical representation 602 of a deterministic consolidated account structure for display within a graphical user interface 604 of a client device 606 associated with the deterministic consolidated account structure. The graphical representation 602 includes a consolidated digital asset value 608 for the deterministic consolidated account structure. The device account consolidation system 100 can generate the consolidated digital asset value 608 as discussed above with reference to FIG. 4 by combining the digital asset values of the underlying digital asset accounts.

As further illustrated, the device account consolidation system 100 determines that a transfer 610 has taken place. FIG. 6A specifically shows the transfer 610 involving a digital asset deposit account, but the transfer 610 can involve other underlying digital asset accounts in other embodiments. Based on the transfer 610, the device account consolidation system 100 modifies the consolidated digital asset value 608 within the graphical representation 602 of the deterministic consolidated account structure. In particular, the device account consolidation system 100 modifies the consolidated digital asset value 608 to reflect the combined digital asset value of the underlying digital asset accounts after the transfer.

Similarly, FIG. 6B illustrates the device account consolidation system 100 providing a graphical representation 612 of a deterministic consolidated account structure, the graphical representation 612 including a consolidated digital asset value 614 for the deterministic consolidated account structure. Further, FIG. 6B illustrates a transfer 616 involving a secured digital asset deposit account that underlies the deterministic consolidated account structure. Based on the transfer, the device account consolidation system 100 modifies the consolidated digital asset value 614 within the graphical representation 612 to reflect the change in the available digital assets of the underlying digital asset accounts.

Thus, in one or more embodiments, the device account consolidation system 100 modifies/updates the consolidated digital asset value generated for a deterministic consolidated account structure based on the changes of the digital asset values of the underlying digital asset accounts. By doing so, the device account consolidation system 100 maintains the presentation of the deterministic consolidated account structure as a single digital asset account representing the underlying accounts. Indeed, while transfers may involve the underlying digital asset accounts and change their respective digital asset values, the device account consolidation system 100 can dynamically present a single consolidated digital asset value for a single account.

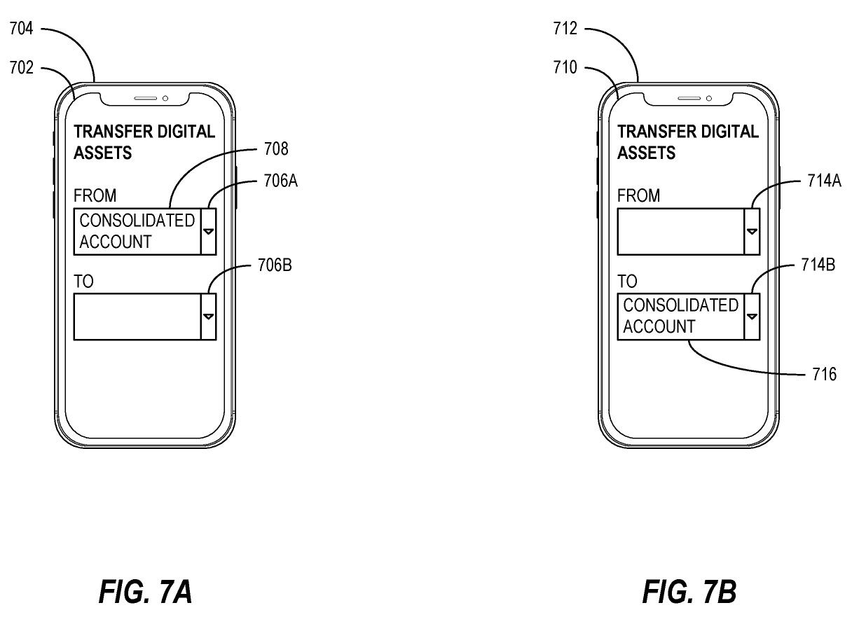

In addition to maintaining an updated digital asset value for a deterministic consolidated account structure in response to transfers involving the underlying digital asset accounts, one or more embodiments of the device account consolidation system 100 enable the deterministic consolidated account structure to be designated as the source account or the destination account in a transfer. FIGS. 7A-7B illustrate the device account consolidation system 100 enabling the deterministic consolidated account structure to be designated as the source account or the destination account in a transfer in accordance with one or more embodiments.

In particular, FIG. 7A illustrates the device account consolidation system 100 providing, within a graphical user interface 702 of a client device 704, selectable options 706a-706b for initiating a transfer. In particular, FIG. 7A illustrates a first selectable option 706a for selecting a source account for the transfer and a second selectable option 706b for selecting a destination account for the transfer. In one or more embodiments, in response to a selection of one of the selectable options 706a-706b, the device account consolidation system 100 provides additional selectable options (e.g., via a drop-down menu) corresponding to the digital asset accounts that are available for inclusion within the transfer.

As shown, the device account consolidation system 100 provides an indication 708 that a deterministic consolidated account structure has been selected as the source account for the transfer. Indeed, the device account consolidation system 100 can present a selectable option corresponding to the deterministic consolidated account structure and designated the structure as the source account upon its selection.

Similarly, FIG. 7B illustrates the device account consolidation system 100 providing, within a graphical user interface 710 of a client device 712, selectable options 714a-714b for initiating a transfer. FIG. 7B further illustrates the device account consolidation system 100 providing an indication 716 that a deterministic consolidated account structure has been selected as the destination account for the transfer.

Thus, the device account consolidation system 100 can present a deterministic consolidated account structure as being involved within a transfer. Indeed, in some cases, the digital assets being transferred are deposited into or withdrawn from a digital asset account underlying the deterministic consolidated account structure, but the device account consolidation system 100 presents the deterministic consolidated account structure itself as being involved in the transfer rather than the underlying account. As will be explained in more detail below, embodiments of the device account consolidation system 100 employ one or more automatic account sweeping protocols to execute the transfer via one or more of the underlying accounts, though the deterministic consolidated account structure is selected as the source account or the destination account. Thus, the device account consolidation system 100 can maintain the presentation that the digital asset accounts of a client device are represented by a single digital asset account (i.e., a pseudo account).

In one or more embodiments, the device account consolidation system 100 implements, for a deterministic consolidated account structure, one or more additional features the correspond to features of digital asset accounts of a digital system. For example, the device account consolidation system 100 can implement features for pausing the deterministic consolidated account structure, closing the deterministic consolidated account structure, and/or reporting suspicious or fraudulent transfer activity involving the deterministic consolidated account structure. In executing each of these features with respect to the deterministic consolidated account structure, the device account consolidation system 100 execute the feature with respect to one or more of the underlying digital asset accounts.

By creating and implementing a deterministic consolidated account structure that represents multiple underlying digital asset accounts, the device account consolidation system 100 operates with improved efficiency when compared to conventional systems. For instance, by creating and implementing consolidation user interface features, the device account consolidation system 100 provides an efficient UI layer that presents the deterministic consolidated account structure as a single digital asset account that can be managed. In response to input with respect to the single digital asset account, the device account consolidation system 100 operates behind the scenes to manage and support the underlying digital asset accounts. By enabling a client device to manage the deterministic consolidated account structure as a single digital asset account—rather than separately manage each underlying digital asset account—the device account consolidation system 100 reduces the user interactions required for account management.

As mentioned, in one or more embodiments, the device account consolidation system 100 implements one or more automatic account sweeping protocols to support a deterministic consolidated account structure of a client device. In particular, the device account consolidation system 100 can use the automatic account sweeping protocol(s) to execute sweeping transfers between the digital asset accounts underlying the deterministic consolidated account structure. FIGS. 8-9F illustrate the device account consolidation system 100 implementing one or more automatic account sweeping protocols in accordance with one or more embodiments.

For instance, FIG. 8 illustrates an overview of the device account consolidation system 100 implementing one or more automatic account sweeping protocols in accordance with one or more embodiments. In particular, as shown, the device account consolidation system 100 receives a transfer request 804 from the client device 802. The client device 802 can include the client device associated with a plurality of digital asset accounts of a digital system (and a deterministic consolidated account structure representing those account) or another computing device, such as a computing device exchanging digital asset with the client device of the digital asset accounts. The transfer request 804 indicates a source account 806, a destination account 808, and a digital asset value 810 to be transferred between the two accounts.

As shown, the device account consolidation system 100 responds to the transfer request 804 by implementing one or more automatic account transfer protocols 812. In particular, the device account consolidation system 100 can execute a transfer in response to the transfer request 804 in accordance with the one or more automatic account transfer protocols 812. As further shown, the one or more automatic account transfer protocols 812 include a predetermined digital asset value 814. In some cases, as will be explained more below, the device account consolidation system 100 uses the one or more automatic account transfer protocols 812 to maintain the predetermined digital asset value 814 for a designated digital asset account. For example, FIG. 8 illustrates that the predetermined digital asset value 814 corresponds to a digital asset deposit account, but the device account consolidation system 100 can associate the predetermined digital asset value 814 with various digital asset accounts in various implementations. In one or more embodiments, the device account consolidation system 100 sets the predetermined digital asset value 814 to zero, but various value amounts can be used in various embodiments.

As further shown in FIG. 8, the device account consolidation system 100 responds to the transfer request 804 by executing an atomic transfer 816 via the one or more automatic account transfer protocols 812. The atomic transfer 816 shown in FIG. 8 includes a sweeping transfer 818 and a digital asset transmission 820. The sweeping transfer 818 includes a transfer of one or more digital assets 822 between a digital asset deposit account 824 of the client device 802 and a secured digital asset deposit account 826 of the client device 802. The digital asset transmission 820 includes a transfer of the one or more digital assets 822 from a source account 828 to a destination account 830. The source account 828 or the destination account 830 can include one of the digital asset accounts of the client device 802 (e.g., one of the accounts underlying the deterministic consolidated account structure), depending on the details of the transfer request 804. Further, the source account 828 or the destination account 830 can include an additional, third-party digital asset account, such as a digital asset account of a computing device exchanging the one or more digital assets 822 with the client device 802. The device account consolidation system 100 can configure the ordering of the sweeping transfer 818 and the digital asset transmission 820 based on the details of the transfer request 804, which will be illustrated further below.

Thus, the device account consolidation system 100 can execute the atomic transfer 816 by executing one or more underlying transfers. In particular, the device account consolidation system 100 can execute one transfer (e.g., a sweeping transfer) between digital asset accounts of the client device 802 and another transfer (e.g., a digital asset transmission) between a digital asset account of the client device 802 and a digital asset account of another computing device. In some cases, as indicated by FIG. 8, the transfer between accounts of digital asset accounts corresponds to the transfer indicated by the transfer request 804, and the device account consolidation system 100 uses one or more sweeping transfers to support the indicated transfer based on the one or more automatic account transfer protocols 812.

As mentioned, in some cases, the device account consolidation system 100 disables access to the one or more digital assets 822 until the atomic transfer 816 is complete. For instance, where the client device 802 has committed the one or more digital assets 822 to transfer to the digital asset account of another computing device, the device account consolidation system 100 can disable access to the one or more digital assets 822 by the client device 802 until the atomic transfer 816 is complete and the one or more digital assets 822 have been moved out of the source account of the client device 802. Thus, the device account consolidation system 100 can prevent the client device 802 from committing the one or more digital assets 822 to another transfer. As such, the device account consolidation system 100 improves security when compared to existing systems by preventing issues with committing the same digital assets to multiple conflicting transfers at the same time.

Further, in some embodiments, the device account consolidation system 100 executes the atomic transfer 816 via the one or more automatic account transfer protocols 812 such that before the atomic transfer 816 and after the atomic transfer 816 the designated digital asset account (e.g., the digital asset deposit account) has the predetermined digital asset value 814. Thus, the device account consolidation system 100 uses the one or more automatic account transfer protocols 812 to maintain a consistent digital asset value within the designated digital asset account.

FIGS. 9A-9F illustrate the device account consolidation system 100 executing various automatic account sweeping protocols in accordance with various embodiments. As mentioned above, and as illustrated in these figures, the device account consolidation system 100 can use the automatic account sweeping protocols to maintain a predetermined digital asset value for a designated digital asset account, such as a digital asset deposit account. Further, as will be illustrated, the device account consolidation system 100 can use the automatic account sweeping protocols to store digital assets in excess of the predetermined digital asset value in another digital asset account, such as a secured digital asset deposit account. Thus, the device account consolidation system 100 can move digital assets between digital asset accounts of a client device in satisfaction of these conditions. To illustrate, where the predetermined digital asset value of a digital asset deposit account is set to zero, the device account consolidation system 100 can move all digital assets deposited into the digital asset deposit account to the secured digital asset deposit account and then move digital assets back to the digital asset deposit account as needed when the digital asset deposit account is invoked to send the digital assets to another account.

FIG. 9A illustrates the device account consolidation system 100 receiving a transfer request 904 from a client device 902 (or another computing device) that indicates that one digital asset is to be transferred from a digital asset account of another computing device to a digital asset deposit account of the client device 902. In response, the device account consolidation system 100 executes an atomic transfer 906 to move the digital asset as indicated by the transfer request 904.

As shown in FIG. 9A, the device account consolidation system 100 executes the atomic transfer 906 by executing a digital asset transmission 908 to transfer the digital asset 910 from the digital asset account 912 (labeled “Account X”) of the other computing device to the digital asset deposit account 914 of the client device 902. The device account consolidation system 100 further executes a sweeping transfer 916 to transfer the digital asset 910 from the digital asset deposit account 914 to a secured digital asset deposit account 918 of the client device 902.

Indeed, FIG. 9A illustrates a scenario in which the device account consolidation system 100 designates the secured digital asset deposit account 918 of the client device 902 as the digital asset account in which to store digital assets (e.g., above the predetermined digital asset value of the digital asset deposit account 914). Thus, while digital assets can be deposited into the digital asset deposit account 914, the device account consolidation system 100 can use the sweeping transfer 916 to move the digital assets into the secured digital asset deposit account 918. As such, the device account consolidation system 100 can use the digital asset deposit account 914 as the source account in a transfer but ultimately stored deposited digital assets into the secured digital asset deposit account 918.

Further, while the device account consolidation system 100 can present a deterministic consolidated account structure as a single digital asset account that is involved in transfers and stores the digital assets of a client device, the device account consolidation system 100 manages the underlying digital asset accounts behind-the-scenes to support this presentation. By using sweeping transfers in conjunction with automatic account sweeping protocols, the device account consolidation system 100 consolidate the digital assets of a client device (digital assets in excess of a predetermined digital asset value) into one of the underlying digital asset accounts. Thus, the device account consolidation system 100 can streamline the implementation of the deterministic consolidated account structure as a single representative digital asset account.

FIG. 9B similarly illustrates the device account consolidation system 100 receiving a transfer request 922 from a client device 920 (or another computing device) that indicates that one digital asset is to be transferred from a digital asset deposit account of the client device 920 to a digital asset account of another computing device. In response, the device account consolidation system 100 executes an atomic transfer 924 to move the digital asset as indicated by the transfer request 922. In particular, the device account consolidation system 100 executes the atomic transfer 924 by executing a sweeping transfer 926 to transfer the digital asset 928 from a secured digital asset deposit account 930 of the client device 920 to the digital asset deposit account 932 of the client device 920. The device account consolidation system 100 further executes a digital asset transmission 934 to transfer the digital asset 910 from the digital asset deposit account 932 of the client device 920 to the digital asset account 936 (labeled “Account X”) of the other computing device.

Indeed, in designating the secured digital asset deposit account 930 of the client device 920 as storing digital assets in excess of a predetermined digital asset value, embodiments of the device account consolidation system 100 move the digital assets as needed from the secured digital asset deposit account 930 to the digital asset deposit account 932 when the digital asset deposit account 932 is invoked in a transfer withdrawing digital assets. Thus, the digital asset deposit account 932 can still be designated as a source account in a transfer, but the device account consolidation system 100 retrieves the digital assets for the transfer from the secured digital asset deposit account 930. The device account consolidation system 100 moves the digital assets to the digital asset deposit account 932 before transferring them to the third-party digital asset account, enabling the digital asset deposit account 932 to act as the source account.

FIG. 9C also illustrates the device account consolidation system 100 receiving a transfer request 940 from a client device 938. The transfer request 940 can represent various types of transfers. As shown, the device account consolidation system 100 executes an atomic transfer 942 in response to the transfer request 940, such as one of the atomic transfers discussed above with reference to FIGS. 9A-9B. As further shown, in addition to the atomic transfer 942, the device account consolidation system 100 executes a cover sweep transfer 944 by transferring one or more digital assets 946 from a digital asset deposit account 948 of the client device 938 to a secured digital asset deposit account 950 of the client device 938. In particular, the device account consolidation system 100 uses the cover sweep transfer 944 to move digital assets in the digital asset deposit account 948 in excess of the predetermined digital asset value to the secured digital asset deposit account 950.

Indeed, in some implementations, the device account consolidation system 100 uses the cover sweep transfer 944 as a failsafe to maintain the predetermined digital asset value of the digital asset deposit account 948. In some cases, other transfers fail to ensure the predetermined digital asset value is maintained; thus, the device account consolidation system 100 employs the cover sweep transfer 944 as an extra sweeping transfer to move digital assets that have previously been missed.

FIG. 9D illustrates the device account consolidation system 100 using a sub-value sweep transfer 952 in accordance with one or more embodiments. As shown in FIG. 9D, a digital asset deposit account 954 of a client device includes a digital asset value that is below a predetermined digital asset value, and a secured digital asset deposit account 956 of the client device includes a positive digital asset value (i.e., a digital asset value above zero). In executing the sub-value sweep transfer 952, the device account consolidation system 100 transfers one or more digital assets 958 stored in the secured digital asset deposit account 956 to the digital asset deposit account 954. For instance, the device account consolidation system 100 can transfer a number of digital assets that increases the digital asset value of the digital asset deposit account 954 to the predetermined digital asset value. Thus, as illustrated in FIGS. 9C-9D, the device account consolidation system 100 can utilize sweeping transfers outside of responding to a transfer request to move digital assets into or out of the digital asset deposit account in maintenance of its predetermined digital asset value.

FIG. 9E illustrates the device account consolidation system 100 using a sub-value sweep transfer 960 in response to a transfer request 962 in accordance with one or more embodiments. Indeed, FIG. 9E illustrates the device account consolidation system 100 receiving, from a client device 964, a transfer request 962 that indicates thirty digital assets are to be transferred from a digital asset account (labeled “Account X”) of another computing device to a secured digital asset deposit account of the client device 964. As shown, the device account consolidation system 100 determines that a digital asset deposit account 966 of the client device 964 has a predetermined digital asset value of zero and a digital asset value of negative ten. In other words, the digital asset value of the digital asset deposit account 966 is below the predetermined digital asset value. For example, the digital asset deposit account 966 can be associated with an overdraft protection feature that enables the digital asset deposit account 966 to withdraw more digital assets than are available (e.g., borrowing the excess digital assets from the digital system), causing the digital asset deposit account 966 to have a negative digital asset value.

As shown in FIG. 9E, the device account consolidation system 100 responds to the transfer request 962 by executing the sub-value sweep transfer 960. The device account consolidation system 100 executes the sub-value sweep transfer 960 by moving a first subset 968 of the digital assets indicated by the transfer request 962 from the digital asset account 970 of the other computing device to the digital asset deposit account 966 of the client device 964 and moving a second subset 972 of the digital assets to the secured digital asset deposit account 974 of the client device 964. Thus, the device account consolidation system 100 can use received digital assets to increase the digital asset value of the digital asset deposit account 966 back to the predetermined digital asset value.

FIG. 9F illustrates the device account consolidation system 100 using an asset load sweep transfer 976 in response to a transfer request 978 in accordance with one or more embodiments. Indeed, FIG. 9F illustrates the device account consolidation system 100 receiving, from a client device 980, a transfer request 978 that indicates thirty digital assets are to be transferred from a digital asset account (labeled “Account X”) of another computing device to a limited digital asset account of the client device 980. FIG. 9F further illustrates that the limited digital asset account 982 includes a digital asset value of negative thirty and a threshold transmission limit of one hundred digital assets. Indeed, as previously mentioned, some embodiments of the device account consolidation system 100 use a credit-based account as the limited digital asset account 982. Thus, the device account consolidation system 100 can create a negative digital asset value for the limited digital asset account 982 in some instances, such as when using the limited digital asset account 982 to transfer digital assets to another account when a (linked) secure digital asset account does not have enough digital assets to cover the transfer.

As shown in FIG. 9F, in response to receiving the transfer request 978, the device account consolidation system 100 executes the asset load sweep transfer 976 by transferring the digital assets 984 indicated by the transfer request 978 from the digital asset account 986 of the other computing device to the secured digital asset deposit account 988 of client device 980. Indeed, rather than transferring the digital assets 984 to the limited digital asset account 982—which would resolve the negative value—the device account consolidation system 100 transfers the digital assets 984 to the secured digital asset deposit account 988. FIG. 9F shows that, as a result of the asset load sweep transfer 976, the limited digital asset account 982 retains the negative digital asset value but includes an increased threshold transmission limit. In particular, the asset load sweep transfer 976 increases the threshold transmission limit by the amount that was transferred into the limited digital asset account 982.

Indeed, as previously suggested, the device account consolidation system 100 can use the secured digital asset deposit account 988 to set the threshold transmission limit for the limited digital asset account 982—based on the digital assets stored in the secured digital asset deposit account 988. Thus, by moving the digital assets 984 into the secured digital asset deposit account 988, the device account consolidation system 100 can increase the threshold transmission limit. In some cases, the device account consolidation system 100 periodically pays off negative values of the limited digital asset account 982 using the digital assets stored in the secured digital asset deposit account 988. Thus, some embodiments of the device account consolidation system 100 can increase the threshold transmission limit without incurring penalties for having a negative digital asset value.

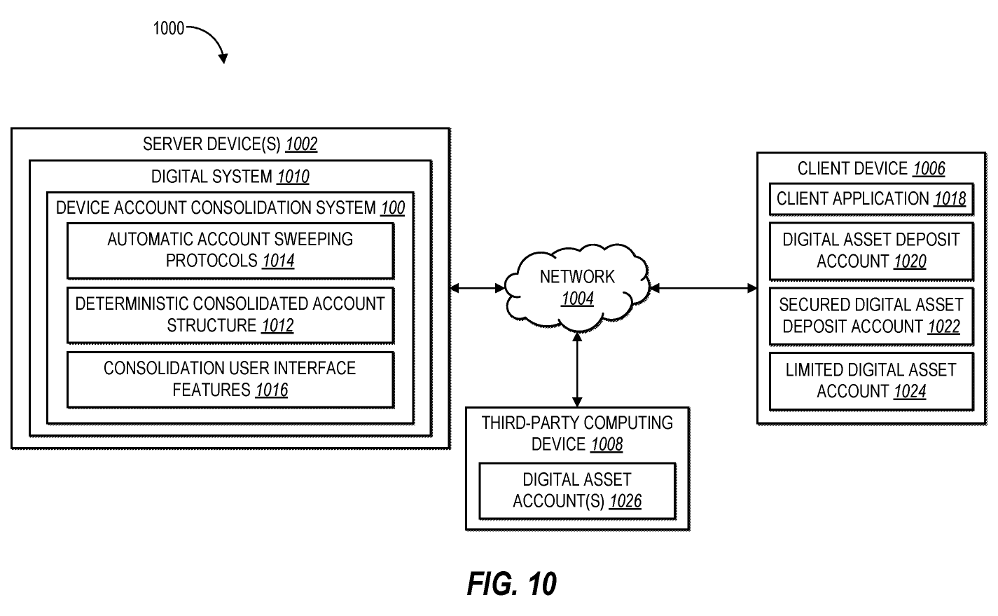

Additional detail regarding the environment within which one or more embodiments of the device account consolidation system 100 operates will now be provided. In particular, FIG. 10 illustrates a block diagram of a system environment (“environment”) 1000 for implementing the device account consolidation system 100 in accordance with one or more embodiments. As illustrated in FIG. 10, the environment 1000 includes a server device(s) 1002, a network 1004, a client device 1006, a third-party computing device 1008.

Although the environment 1000 of FIG. 10 is depicted as having a particular number of components, the environment 1000 can have any number of additional or alternative components (e.g., a different number of server devices, client devices, third-party computing devices, or other components in communication with the device account consolidation system 100 via the network 1004). Similarly, although FIG. 10 illustrates a particular arrangement of the server device(s) 1002, the network 1004, the client device 1006, and the third-party computing device 1008, various additional arrangements are possible.

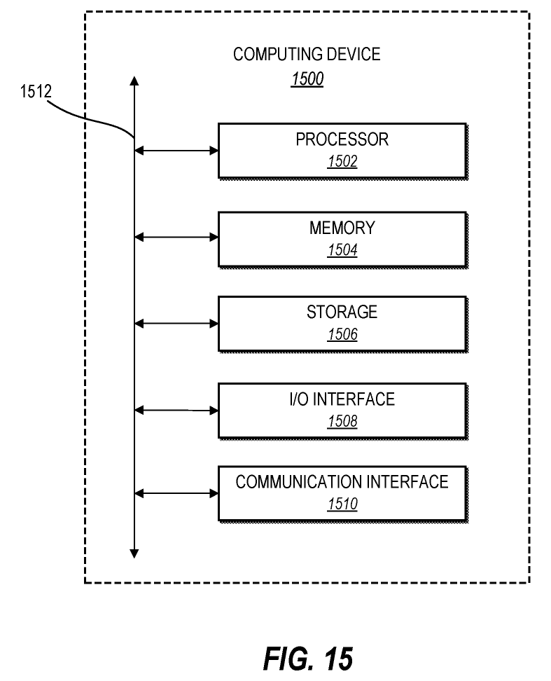

The server device(s) 1002, the network 1004, the client device 1006, and the third-party computing device 1008 can be communicatively coupled with each other either directly or indirectly (e.g., through the network 1004 as discussed in greater detail below in relation to FIG. 15). Moreover, the server device(s) 1002, the client device 1006, and the third-party computing device 1008 may include a variety of computing devices (including one or more computing devices as discussed in greater detail with relation to FIG. 15).

As mentioned, the environment 1000 includes the server device(s) 1002. In one or more embodiments, the server device(s) 1002 generates, stores, receives, and/or transmits digital data, including digital data related to the creation and management of digital asset accounts of a digital system 1010. For example, the server device(s) 1002 can receive, from the client device 1006, a request to create multiple digital asset accounts within the digital system 1010 and provide information and visual presentations regarding the digital asset accounts in return. In one or more embodiments, the server device(s) 1002 comprises a data server. In some embodiments, the server device(s) 1002 comprises a communication server or a web-hosting server.

As shown, the server device(s) 1002 includes the digital system 1010. In one or more embodiments, the digital system 1010 provides a collection of digital services and/or features. Further, the digital system 1010 can manage various digital asset accounts. For example, the digital system 1010 can create digital asset accounts and/or provide at least some of the digital services to each of the digital asset accounts.

Additionally, the server device(s) 1002 include the device account consolidation system 100. In particular, in one or more embodiments, the device account consolidation system 100 uses the server device(s) 1002 to create deterministic consolidated account structures for client devices within the digital system 1010. For example, in some embodiments, the device account consolidation system 100 creates a deterministic consolidated account structure 1012 for a client device having multiple digital asset accounts within the digital system 1010. The device account consolidation system 100 can employ automatic account sweeping protocols 1014 to support transfers involving the deterministic consolidated account structure 1012 (e.g., one or more of the underlying digital asset accounts). Further, the device account consolidation system 100 can use consolidation user interface features 1016 to create and provide graphical representations that present the deterministic consolidated account structure 1012 as a single digital asset account.

In one or more embodiments, the client device 1006 includes a computing device that can access the digital system 1010 (e.g., to manage digital asset accounts or utilize the services and/or feature offered). For example, in some implementations, the client device 1006 includes at least one of a smartphone, a tablet, a desktop computer, a laptop computer, a head-mounted-display device, or other electronic device. In some instances, the client device 1006 includes one or more applications (e.g., the client application 1018) that can access the digital system 1010 (e.g., to manage digital asset accounts or utilize the services and/or feature offered). For example, in some embodiments, the client application 1018 includes a software application installed on the client device 1006. In other cases, however, the client application 1018 includes a software application hosted on the server device(s) 1002 (and supported by the digital system 1010), which is accessible by the client device 1006 through another application, such as a web browser.

As further shown, the client device 1006 includes or is otherwise associated with various digital asset accounts of the digital system 1010. In particular, the client device 1006 includes or is otherwise associated with a digital asset deposit account 1020, a secured digital asset deposit account 1022, and a limited digital asset account 1024. In some implementations, these digital asset accounts are not stored on the client device; rather, they are stored by the digital system 1010 (e.g., on the server device(s) 1002). Further, the digital asset accounts are accessible to the client device 1006 (e.g., by accessing the digital system 1010 via the client application 1018).

Additionally, in one or more embodiments, the third-party computing device 1008 includes or is otherwise associated with one or more digital asset accounts 1026—whether they are digital asset accounts of the digital system 1010 or of another platform. The third-party computing device 1008 can uses the one or more digital asset accounts 1026 to exchange digital assets with the digital asset accounts of the client device 1006. For instance, the third-party computing device 1008 can initiate a transfer or be the recipient of a transfer initiated by the client device 1006.

The device account consolidation system 100 can be implemented in whole, or in part, by the individual elements of the environment 1000. Indeed, although FIG. 10 illustrates the device account consolidation system 100 implemented with regard to the server device(s) 1002, different components of the device account consolidation system 100 can be implemented by a variety of devices within the environment 1000. For example, one or more (or all) components of the device account consolidation system 100 can be implemented by a different computing device (e.g., the client device 1006) or a separate server device from the server device(s) 1002 hosting the digital system 1010.

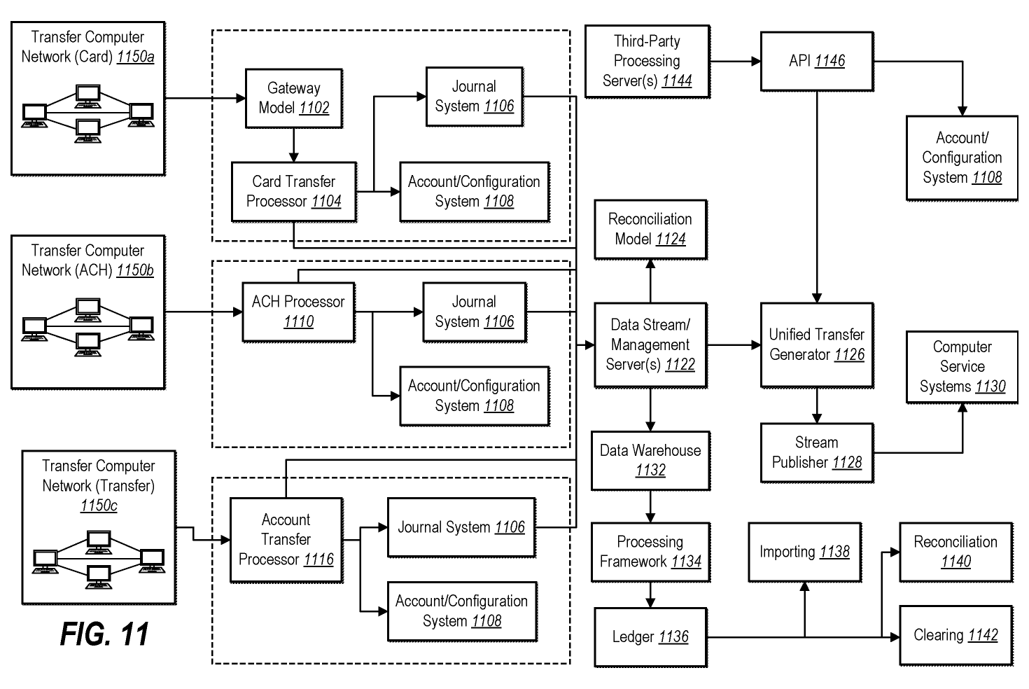

As indicated above, in one or more embodiments, the device account consolidation system 100 operates within a larger platform of the digital system 1010. For example, FIG. 11 illustrates a platform in which the device account consolidation system 100 operates in accordance with one or more embodiments. Indeed, FIG. 11 illustrates the transfer computer networks 1150a-1150c providing transfer information corresponding to different transfer types (e.g., card, ACH, or other transfers). The digital system 1010 receives and processes this transfer information utilizing a variety of computer implemented models and procedures.

For example, as shown in FIG. 11, the digital system 1010 utilizes a gateway model 1102 to analyze transfer information from the transfer computer network 1150a (e.g., a card transfer computer network). The gateway model 1102 performs an initial analysis of the transfer information (e.g., accepts or rejects the transfer based on gateway criteria). Moreover, the digital system 1010 also analyzes the transfer information utilizing the card transfer processor 1104. In one or more embodiments, the card transfer processor 1104 extracts and analyzes information for the digital system 1010. For example, in some embodiments, the card transfer processor 1104 transforms and converts information from the transfer computer network 1150a for further analysis within the digital system 1010. In some embodiments, the card transfer processor 1104 assists in converting a network schema to a unified transfer schema.

As shown, the card transfer processor 1104 also communicates with a journal system and an account/configuration system 1108. For example, the account/configuration system 1108 can verify that the digital system 1010 has a digital asset account corresponding to the transfer information, whether the digital asset account has digital assets for the transfer, etc. Moreover, the account/configuration system 1108 can determine configurations corresponding to the transfer (e.g., configurations that define pipelines, procedures within the digital system 1010 for implementation the transfer). The journal system 1106 tracks and manages digital asset movement for a transfer. For example, the journal system 1106 records asset movement for digital asset accounts corresponding to transfers.

As shown, the journal system 1106 and/or the card transfer processor 1104 emit transfer information, such as events, to data management server(s) 1122. The data management server(s) 1122 can store, process, provide, and/or report transfer information. For example, as illustrated, the data management server(s) 1122 can provide transfer information to a reconciliation model 1124 (e.g., to reconcile transfer information with the transfer computer network 1150a). Similarly, the data management server(s) 1122 can provide transfer information to a data warehouse 1132 for further processing (via the processing framework 1134) entry into a ledger 1136 (or system of record), and further analysis via importing 1138 (e.g., institution/entity importing), reconciliation 1140 (e.g., reconciliation of the ledger or system of record), or clearing 1142 processes/models. Indeed, in one or more embodiments, the journal system 1106 exports transfer information (via the data management server(s) 1122, and the data warehouse 1132) to maintain a system of record for transfers across the digital system 1010.

The digital system 1010 performs similar functions with regard to the transfer computer networks 1150b, 1150c (e.g., ACH transfer computer networks and other transfer computer networks). As shown, the digital system 1010 utilizes an ACH processor 1110 to process transfer information from the transfer computer network 1150b (e.g., similar to the card transfer processor 1104). Moreover, the digital system 1010 utilizes the journal system 1106 and the account/configuration system 1108 to transmit transfer events to the data management server(s) 1122. Similarly, the digital system 1010 utilizes an account transfer processor 1116 to process transfer information from the transfer computer network 1150c (e.g., similar to the card transfer processor 1104). Moreover, the digital system 1010 utilizes the journal system 1106 and the account/configuration system 1108 to transmit transfer events corresponding to the transfer computer network 1150c to the data management server(s) 1122.

As shown in FIG. 11, the digital system 1010 utilizes a unified transfer generator 1126 to generate unified transfer containers for individual transfers. As shown, the unified transfer generator 1126 can combine transfer information from different transfer computer networks 1150a-1150c. As shown, the unified transfer generator 1126 can also generate unified transfer containers from transfer information received from third-party processing server(s) 1144.

For example, the third-party processing server(s) 1144 can work in conjunction with the digital system 1010 to provide additional bandwidth, throughput, or redundancy in processing transfers from the transfer computer networks 1150a-1150c. In some implementations, the third-party processing server(s) 1144 receive and process transfer information. The digital system 1010 can utilize an API 1146 to import the transfer information (and utilize the account/configuration system 1108 to verify digital asset account information and obtain configuration information necessary to feed the transfer information through the remainder of the digital system 1010). The unified transfer generator 1126 receives this transfer information and generates unified transfer containers (e.g., by converting the transfer information, if necessary, and populating unified transfer containers with pertinent information extracted from the transfer information).

Moreover, the digital system 1010 publishes a unified transaction stream utilizing a stream publisher 1128. As show, the stream publisher 1128 provides the unified transaction stream to computer service systems 1130. Thus, the unified transaction stream can include information from the transaction computer networks 1150a-1150c and information from the third-party processing server(s) 1144.

In one or more embodiments, the device account consolidation system 100 operates in conjunction with the journal system 1106. For instance, in some embodiments, the device account consolidation system 100 employs the journal system 1106 to execute transfers (e.g., atomic transfers) and track the movement of digital assets among the digital asset accounts maintained at the digital system 1010. In some instances, the device account consolidation system 100 uses the journal system 1106 exclusively to execute transfers, preventing delays that would be caused by communications among various sub-systems. Thus, in some implementations, the device account consolidation system 100 increases the efficiency with which transfers are executed and prevents potential errors due to failed communications.

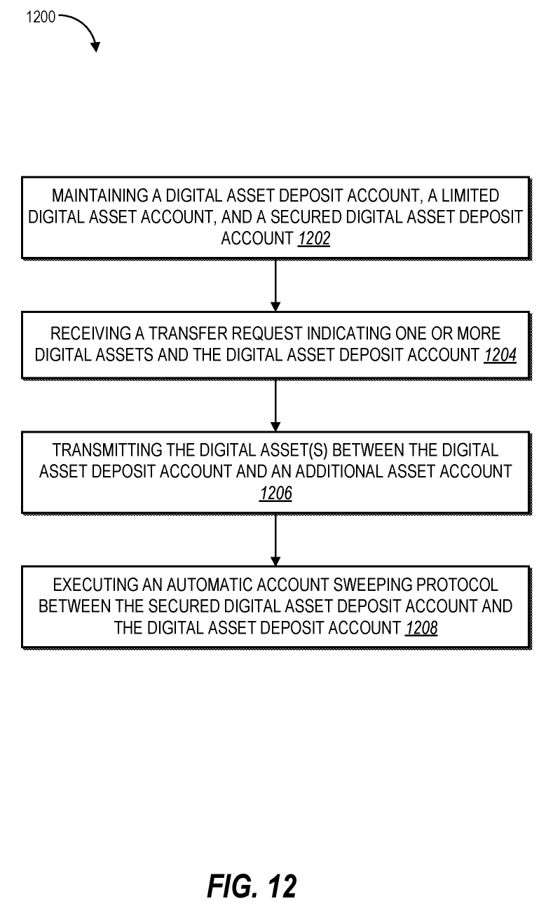

FIGS. 1-11, the corresponding text and the examples provide a number of different methods, systems, devices, and non-transitory computer-readable media of the device account consolidation system 100. In addition to the foregoing, one or more embodiments can also be described in terms of flowcharts comprising acts for accomplishing particular results, as shown in FIGS. 12-14. FIGS. 12-14 may be performed with more or fewer acts. Further, the acts may be performed in different orders. Additionally, the acts described herein may be repeated or performed in parallel with one another or in parallel with different instances of the same or similar acts.

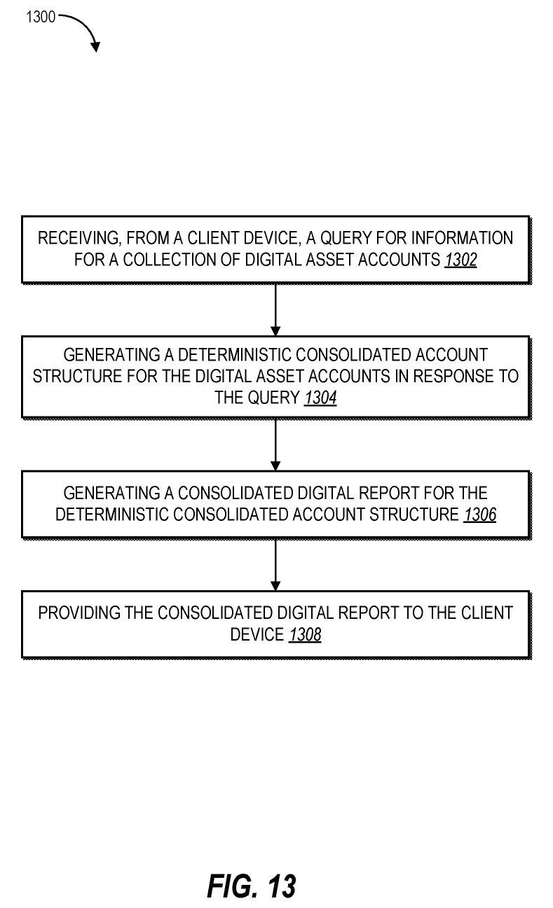

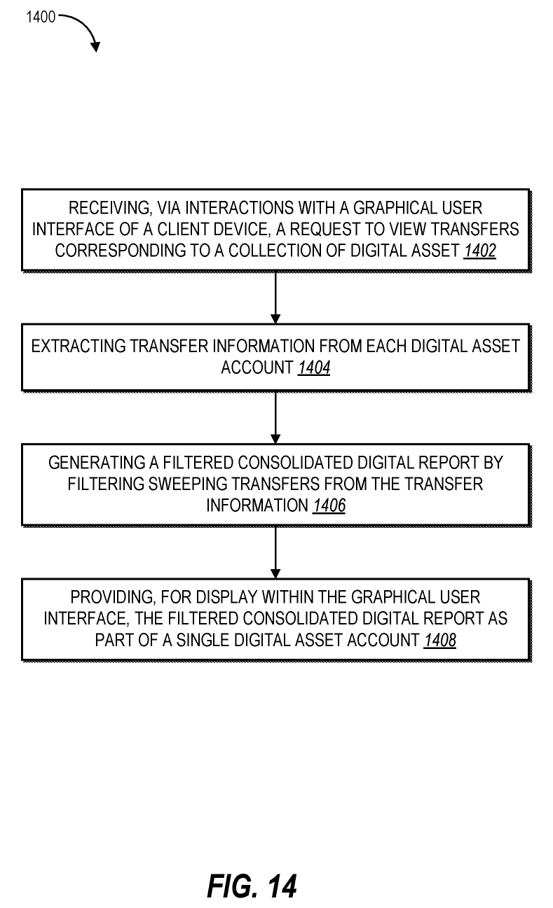

FIGS. 12-14 illustrate flowcharts for various series of acts. For example, FIG. 12 illustrates a flowchart of a series of acts 1200 for executing an atomic transfer using an automatic account sweeping protocol in accordance with one or more embodiments. FIG. 13 illustrates a flowchart of a series of acts 1300 for generating a consolidated digital report for a deterministic consolidated account structure of a client device in accordance with one or more embodiments. FIG. 14 illustrates a flowchart of a series of acts 1400 for generating a filtered consolidated digital report for a collection of digital asset accounts of a client device in accordance with one or more embodiments. FIGS. 12-14 each illustrate acts according to one embodiment, but alternative embodiments may omit, add to, reorder, and/or modify any of the acts shown in FIGS. 12-14. In some implementations, the acts of FIGS. 12-14 are performed as part of a computer-implemented method. Alternatively, a non-transitory computer-readable medium can store instructions thereon that, when executed by at least one processor, cause a computing device to perform the acts of any one of FIGS. 12-14. In some embodiments, a system performs the acts of any one of FIGS. 12-14. For example, in one or more embodiments, a system includes at least one processor. The system further includes a non-transitory computer-readable medium storing instructions that, when executed by the at least one processor, cause the system to perform the acts of any one of FIGS. 12-14.

As shown in FIG. 12, the series of acts 1200 includes an act 1202 for maintaining a digital asset deposit account, a limited digital asset account, and a secured digital asset deposit account. For example, in one or more embodiments, the act 1202 involves maintaining, at one or more servers for a client corresponding to a client device, a collection of digital asset accounts comprising a limited digital asset account, a secured digital asset deposit account linked to the limited digital asset account to set a threshold transmission limit for the limited digital asset account, and a digital asset deposit account.

The series of acts 1200 also includes an act 1204 for receiving a transfer request indicating one or more digital assets and the digital asset deposit account. For instance, in some embodiments, the act 1204 involves receiving, from a computing device (e.g., the client device or another computing device), a transfer request indicating one or more digital assets and the digital asset deposit account.

Additionally, the series of acts 1200 includes an act 1206 for transmitting the digital asset(s) between the digital asset deposit account and an additional digital asset account. To illustrate, in some cases, the act 1206 involves executing, utilizing an automatic account sweeping protocol across the collection of digital asset accounts, an atomic transfer in response to the transfer request by transmitting the one or more digital assets between the digital asset deposit account and an additional digital asset account.

The series of acts 1200 further includes an act 1208 for executing an automatic account sweeping protocol between the secured digital asset deposit account and the digital asset deposit account. For example, in certain embodiments, the act 1208 involves executing the atomic transfer by further executing the automatic account sweeping protocol between the secured digital asset deposit account and the digital asset deposit account such that before the atomic transfer and after the atomic transfer the digital asset deposit account has a predetermined digital asset value.

In one or more embodiments, transmitting the one or more digital assets between the digital asset deposit account and the additional digital asset account comprises depositing the one or more digital assets into the digital asset deposit account from the additional digital asset account; and executing the automatic account sweeping protocol between the secured digital asset deposit account and the digital asset deposit account comprises sweeping the one or more digital assets deposited in the digital asset deposit account to the secured digital asset deposit account. In some cases, the device account consolidation system 100 further determines, after sweeping the one or more digital assets from the digital asset deposit account to the secured digital asset deposit account, that the digital asset deposit account contains at least one digital asset above the predetermined digital asset value; and executes an additional automatic account sweeping protocol by sweeping the at least one digital asset from the digital asset deposit account to the secured digital asset deposit account.

In some implementations, receiving the transfer request indicating one or more digital assets and the digital asset deposit account comprises receiving the transfer request to use the one or more digital assets via the digital asset deposit account; executing the automatic account sweeping protocol between the secured digital asset deposit account and the digital asset deposit account comprises sweeping the one or more digital assets from the secured digital asset deposit account to the digital asset deposit account in response to the transfer request; and transmitting the one or more digital assets between the digital asset deposit account and the additional digital asset account comprises transferring the one or more digital assets swept into the digital asset deposit account to the additional digital asset account.

Additionally, in certain embodiments, the device account consolidation system 100 further receives, from the computing device, an additional transfer request to deposit one or more additional digital assets into the secured digital asset deposit account; determines that the digital asset deposit account includes a digital asset value that is below the predetermined digital asset value; and executes an additional automatic account sweeping protocol by transferring at least one digital asset from the one or more additional digital assets into the digital asset deposit account such that the digital asset value of the digital asset deposit account equals the predetermined digital asset value. In some instances, receiving the additional transfer request to deposit the one or more additional digital assets into the secured digital asset deposit account comprises receiving the additional transfer request to deposit a plurality of digital assets into the secured digital asset deposit account; and executing the additional automatic account sweeping protocol by transferring the at least one digital asset into the digital asset deposit account comprises transferring a first subset of digital assets from the plurality of digital assets into the digital asset deposit account. As such, in some embodiments, the device account consolidation system 100 further transfers, via the additional automatic account sweeping protocol, a second subset of digital assets from the plurality of digital assets into the digital asset deposit account.

In one or more embodiments, the device account consolidation system 100 further determines that the digital asset deposit account includes a digital asset value that is below the predetermined digital asset value and the secured digital asset deposit account has a positive digital asset value; and executes an additional automatic account sweeping protocol by transferring at least one digital asset from the secured digital asset deposit account into the digital asset deposit account such that the digital asset value of the digital asset deposit account equals the predetermined digital asset value. Additionally, in some embodiments, the device account consolidation system 100 further receives, via an additional computing device, an additional transfer request to attribute one or more additional digital assets toward the limited digital asset account; and transfers, in response to the additional transfer request, the one or more digital assets to the secured digital asset deposit account to increase the threshold transmission limit of the limited digital asset account. In some cases, the device account consolidation system 100 further disables access to the one or more digital assets by the client device until after the atomic transfer is complete.

Further, in certain implementations, executing the automatic account sweeping protocol such that before the atomic transfer and after the atomic transfer the digital asset deposit account has a predetermined digital asset value comprises executing the automatic account sweeping protocol such that before the atomic transfer and after the atomic transfer the digital asset deposit account has a digital asset value of zero.

As shown in FIG. 13, the series of acts 1300 includes an act 1302 for receiving, from a client device, a query for information for a collection of digital asset accounts. For example, in one or more embodiments, the act 1302 involves receiving, from a client device, a query for information for a collection of digital asset accounts corresponding to the client device, the collection of digital asset accounts comprising: a digital asset deposit account, a limited digital asset account comprising a threshold transmission limit, and a secured digital asset deposit account that is linked to the limited digital asset account to set the threshold transmission limit for the limited digital asset account.

The series of acts 1300 also includes an act 1304 for generating a deterministic consolidated account structure for the digital asset accounts in response to the query. For instance, in some embodiments, the act 1304 involves generating, for the client device and in response to the query, a deterministic consolidated account structure for the collection of digital asset accounts of the client device based on features of the collection of digital asset accounts.

Additionally, the series of acts 1300 includes an act 1306 for generating a consolidated digital report for the deterministic consolidated account structure. To illustrate, in some cases, the act 1306 involves generating, for the deterministic consolidated account structure, a consolidated digital report that includes account data extracted from the collection of digital asset accounts and responsive to the query.

The series of acts 1300 also includes an act 1308 for providing the consolidated digital report to the client device. For example, in certain embodiments, the act 1308 involves providing the consolidated digital report to the client device in association with the deterministic consolidated account structure.

In one or more embodiments, the device account consolidation system 100 extracts, from client data associated with the client device, an indication that that client device has opted in to a consolidated account that represents the collection of digital asset accounts. As such, in some cases, generating the deterministic consolidated account structure in response to the query comprises generating the deterministic consolidated account structure in response to the query and based on the indication that the client device has opted in to the consolidated account.

In some embodiments, the device account consolidation system 100 retrieves, in response to detecting that the client device has accessed a client application for managing digital asset accounts, the collection of digital asset accounts from a client-to-accounts mapping. Further, in some cases, generating the deterministic consolidated account structure in response to the query for the information comprises generating the deterministic consolidated account structure as part of a workflow for responding to the query without storing the deterministic consolidated account structure in the client-to-accounts mapping.

In one or more embodiments, generating the deterministic consolidated account structure for the collection of digital asset accounts comprises generating a deterministic account identifier that identifies the deterministic consolidated account structure as a consolidated account type; and generating the consolidated digital report for the deterministic consolidated account structure comprises generating the consolidated digital report using the deterministic account identifier. Further, in some embodiments, generating the deterministic account identifier comprises: determining a client identifier that corresponds to the client device; and generating the deterministic account identifier for the deterministic consolidated account structure by encoding the client identifier. In some implementations, generating the consolidated digital report for the deterministic consolidated account structure using the deterministic account identifier comprises: determining that the digital asset deposit account and the limited digital asset account are associated with the deterministic account identifier; extracting, from a transfer database, a first set of transfers involving the digital asset deposit account using a first account identifier for the digital asset deposit account; extracting, from the transfer database, a second set of transfers involving the limited digital asset account using a second account identifier for the limited digital asset account; and aggregating the first set of transfers and the second set of transfers into a single set of transfers involving the deterministic consolidated account structure.

In some embodiments, generating the deterministic consolidated account structure for the collection of digital asset accounts of the client device based on features of the collection of digital asset accounts comprises generating a set of representative features for the deterministic consolidated account structure using a first set of features from the digital asset deposit account and a second set of features from the secured digital asset deposit account. Additionally, in some cases, providing the consolidated digital report to the client device in association with the deterministic consolidated account structure comprises providing the consolidated digital report to the client device as a representation of the collection of digital asset accounts without providing separate account data for each individual digital asset account from the collection of digital asset accounts.

As shown in FIG. 14, the series of acts 1400 includes an act 1402 for receiving, via interactions with a graphical user interface of a client device, a request to view transfers corresponding to a collection of digital assets. For example, in one or more embodiments, the act 1402 involves receiving, via one or more interactions with a graphical user interface of a client device having a collection of digital asset accounts within a digital system, a request to view transfers corresponding to the collection of digital asset accounts, the collection of digital asset accounts comprising: a digital asset deposit account, a limited digital asset account comprising a threshold transmission limit, and a secured digital asset deposit account that is linked to the limited digital asset account to set the threshold transmission limit for the limited digital asset account.

The series of acts 1400 also includes an act 1404 for extracting transfer information from each digital asset account. Indeed, in some embodiments, the act 1404 involves, in response to the request, extracting transfer information from each digital asset account of the collection of digital asset accounts.

Additionally, the series of acts 1400 includes an act 1406 for generating a filtered consolidated digital report by filtering sweeping transfers from the transfer information. To illustrate, in some cases, the act 1406 involves, in response to the request, generating a filtered consolidated digital report using the transfer information from each digital asset account by filtering sweeping transfers between the collection of digital asset accounts.

The series of acts 1400 further includes an act 1408 for providing, for display within the graphical user interface, the filtered consolidated digital report as part of a single digital asset account. For instance, in some implementations, the act 1408 involves, in response to the request, providing, for display within the graphical user interface of the client device, the filtered consolidated digital report as part of a graphical representation of a single digital asset account that represents the collection of digital asset accounts.

In one or more embodiments, generating the filtered consolidated digital report by filtering the sweeping transfers between the collection of digital asset accounts comprises: extracting, from the transfer information of each digital asset account, a set of deposits into the collection of digital asset accounts and a set of withdrawals from the collection of digital asset accounts; extracting, from the transfer information of each digital asset account, one or more sweeping transfers executed in support of the set of deposits and the set of withdrawals; and generating the filtered consolidated digital report to include the set of deposits and the set of withdrawals and to exclude the one or more sweeping transfers.

In some cases, the device account consolidation system 100 generates an account statement for the digital asset deposit account that includes: a set of deposits into the digital asset deposit account; a set of withdrawals from the digital asset deposit account; and a set of sweeping transfers between the digital asset deposit account and the secured digital asset deposit account executed in support of the set of deposits and the set of withdrawals. Further, the device account consolidation system 100 provides the account statement for display within the graphical user interface of the client device in response to a user interaction to view the account statement. In some embodiments, the device account consolidation system 100 provides, for display, within the graphical user interface of the client device, a selectable option corresponding to the single digital asset account as a source account in a transfer of one or more digital assets; and transmits, based on a user selection of the selectable option, the one or more digital assets from the digital asset deposit account represented by the single digital asset account to an additional digital asset account. Additionally, in certain implementations, the device account consolidation system 100 provides, for display, within the graphical user interface of the client device, a selectable option corresponding to the single digital asset account as a destination account in a transfer of one or more digital assets; and transmits, in response to detecting a user selection of the selectable option, the one or more digital assets from an additional digital asset account to the digital asset deposit account represented by the single digital asset account.

In one or more embodiments, the device account consolidation system 100 generates a consolidated digital asset value by combining a first digital asset value of the digital asset deposit account and a second digital asset value of the secured digital asset deposit account; and provides, for display within the graphical user interface of the client device, the consolidated digital asset value as part of the graphical representation of the single digital asset account. In some instances, the device account consolidation system 100 further modifies the consolidated digital asset value for the single digital asset account in response to a first transfer of one or more digital assets involving the digital asset deposit account; updates the modified consolidated digital asset value for the single digital asset account in response to a second transfer of one or more additional digital assets involving the secured digital asset deposit account; and provides, for display within the graphical user interface of the client device, the updated consolidated digital asset value as part of the graphical representation of the single digital asset account. In some cases, providing the consolidated digital asset value for display within the graphical user interface of the client device comprises providing the consolidated digital asset value for display while hiding individual digital asset values of the collection of digital asset accounts from display.

In one or more embodiments, the device account consolidation system 100 further provides, for display within the graphical user interface, an interactive option for further filtering the filtered consolidated digital report by digital asset account; and modifies, within the graphical user interface, the filtered consolidated digital report to show transfers involving the digital asset account from the collection of digital asset accounts selected via a user interaction with the interactive option and hide other transfers involving other digital asset accounts from the collection of digital asset accounts.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed by a general-purpose computer to turn the general-purpose computer into a special purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. As used herein, the term “cloud computing” refers to a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In addition, as used herein, the term “cloud-computing environment” refers to an environment in which cloud computing is employed.

FIG. 15 illustrates a block diagram of an example computing device 1500 that may be configured to perform one or more of the processes described above. One will appreciate that one or more computing devices, such as the computing device 1500 may represent the computing devices described above (e.g., the server device(s) 1002, the client device 1006, and/or the third-party computing device 1008). In one or more embodiments, the computing device 1500 may be a mobile device (e.g., a mobile telephone, a smartphone, a PDA, a tablet, a laptop, a camera, a tracker, a watch, a wearable device, etc.). In some embodiments, the computing device 1500 may be a non-mobile device (e.g., a desktop computer or another type of client device). Further, the computing device 1500 may be a server device that includes cloud-based processing and storage capabilities.

As shown in FIG. 15, the computing device 1500 can include one or more processor(s) 1502, memory 1504, a storage device 1506, input/output interfaces 1508 (or “I/O interfaces 1508”), and a communication interface 1510, which may be communicatively coupled by way of a communication infrastructure (e.g., bus 1512). While the computing device 1500 is shown in FIG. 15, the components illustrated in FIG. 15 are not intended to be limiting. Additional or alternative components may be used in other embodiments. Furthermore, in certain embodiments, the computing device 1500 includes fewer components than those shown in FIG. 15. Components of the computing device 1500 shown in FIG. 15 will now be described in additional detail.

In particular embodiments, the processor(s) 1502 includes hardware for executing instructions, such as those making up a computer program. As an example, and not by way of limitation, to execute instructions, the processor(s) 1502 may retrieve (or fetch) the instructions from an internal register, an internal cache, memory 1504, or a storage device 1506 and decode and execute them.

The computing device 1500 includes memory 1504, which is coupled to the processor(s) 1502. The memory 1504 may be used for storing data, metadata, and programs for execution by the processor(s). The memory 1504 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 1504 may be internal or distributed memory.

The computing device 1500 includes a storage device 1506 includes storage for storing data or instructions. As an example, and not by way of limitation, the storage device 1506 can include a non-transitory storage medium described above. The storage device 1506 may include a hard disk drive (HDD), flash memory, a Universal Serial Bus (USB) drive or a combination these or other storage devices.

As shown, the computing device 1500 includes one or more I/O interfaces 1508, which are provided to allow a user to provide input to (such as user strokes), receive output from, and otherwise transfer data to and from the computing device 1500. These I/O interfaces 1508 may include a mouse, keypad or a keyboard, a touch screen, camera, optical scanner, network interface, modem, other known I/O devices or a combination of such I/O interfaces 1508. The touch screen may be activated with a stylus or a finger.

The I/O interfaces 1508 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 1508 are configured to provide graphical data to a display for presentation to a user. The graphical data may be representative of one or more graphical user interfaces and/or any other graphical content as may serve a particular implementation.

The computing device 1500 can further include a communication interface 1510. The communication interface 1510 can include hardware, software, or both. The communication interface 1510 provides one or more interfaces for communication (such as, for example, packet-based communication) between the computing device and one or more other computing devices or one or more networks. As an example, and not by way of limitation, communication interface 1510 may include a network interface controller (NIC) or network adapter for communicating with an Ethernet or other wire-based network or a wireless NIC (WNIC) or wireless adapter for communicating with a wireless network, such as a WI-FI. The computing device 1500 can further include a bus 1512. The bus 1512 can include hardware, software, or both that connects components of computing device 1500 to each other.

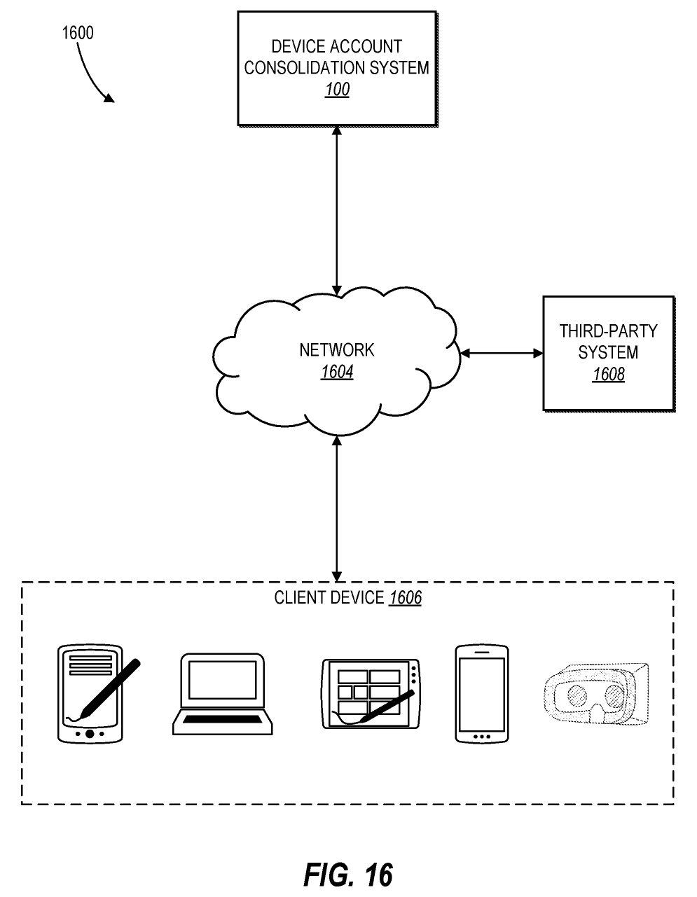

FIG. 16 illustrates an example network environment 1600 of the device account consolidation system 100. The network environment 1600 includes client device(s) 1606 (e.g., client device 1006), the device account consolidation system 100, and third-party system(s) 1608 connected to each other by network(s) 1604. Although FIG. 16 illustrates a particular arrangement of the client device(s) 1606, the device account consolidation system 100, the third-party system(s) 1608, and the network(s) 1604, this disclosure contemplates any suitable arrangement of the client device(s) 1606, the device account consolidation system 100, the third-party system(s) 1608, and the network(s) 1604. As an example, and not by way of limitation, two or more of the client device(s) 1606, the device account consolidation system 100, and the third-party system(s) 1608 communicate directly, bypassing the network(s) 1604. As another example, two or more of the client device(s) 1606, the device account consolidation system 100, and the third-party system(s) 1608 may be physically or logically co-located with each other in whole or in part.

Moreover, although FIG. 16 illustrates a particular number of the client device(s) 1606, the device account consolidation system 100, the third-party system(s) 1608, and the network(s) 1604, this disclosure contemplates any suitable number of the client device(s) 1606, device account consolidation systems, the third-party system(s) 1608, and the network(s) 1604. As an example, and not by way of limitation, network environment 1600 may include multiple client devices, inter-network facilitation systems, third-party systems, and/or networks.

This disclosure contemplates any suitable network for the network(s) 1604. As an example, and not by way of limitation, one or more portions of the network(s) 1604 may include an ad hoc network, an intranet, an extranet, a virtual private network (“VPN”), a local area network (“LAN”), a wireless LAN (“WLAN”), a wide area network (“WAN”), a wireless WAN (“WWAN”), a metropolitan area network (“MAN”), a portion of the Internet, a portion of the Public Switched Telephone Network (“PSTN”), a cellular telephone network, or a combination of two or more of these. The network(s) 1604 may include one or more networks.

Links may connect the client device(s) 1606, the device account consolidation system 100, and the third-party system(s) 1608 to the network(s) 1604 or to each other. This disclosure contemplates any suitable links. In particular embodiments, one or more links include one or more wireline (such as for example Digital Subscriber Line (“DSL”) or Data Over Cable Service Interface Specification (“DOCSIS”), wireless (such as for example Wi-Fi or Worldwide Interoperability for Microwave Access (“WiMAX”), or optical (such as for example Synchronous Optical Network (“SONET”) or Synchronous Digital Hierarchy (“SDH”) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout network environment 1600. One or more first links may differ in one or more respects from one or more second links.

In particular embodiments, the client device(s) 1606 may be an electronic device including hardware, software, or embedded logic components or a combination of two or more such components and capable of carrying out the appropriate functionalities implemented or supported by the client device(s) 1606. As an example, and not by way of limitation, the client device(s) 1606 may include any of the computing devices discussed above in relation to FIG. 15. The client device(s) 1606 may enable a network user at the client device(s) 1606 to access the network(s) 1604. The client device(s) 1606 may enable its user to communicate with other users at other client devices of the client device(s) 1606.

In particular embodiments, the client device(s) 1606 may include a requester application or a web browser, such as MICROSOFT INTERNET EXPLORER, GOOGLE CHROME, or MOZILLA FIREFOX, and may have one or more add-ons, plug-ins, or other extensions, such as TOOLBAR or YAHOO TOOLBAR. A user at the client device(s) 1606 may enter a Uniform Resource Locator (“URL”) or other address directing the web browser to a particular server (such as server), and the web browser may generate a Hyper Text Transfer Protocol (“HTTP”) request and communicate the HTTP request to server. The server may accept the HTTP request and communicate to the client device(s) 1606 one or more Hyper Text Markup Language (“HTML”) files responsive to the HTTP request. The client device(s) 1606 may render a webpage based on the HTML files from the server for presentation to the user. This disclosure contemplates any suitable webpage files. As an example, and not by way of limitation, webpages may render from HTML files, Extensible Hyper Text Markup Language (“XHTML”) files, or Extensible Markup Language (“XML”) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, the device account consolidation system 100 may be a network-addressable computing system that can interface between two or more computing networks or servers associated with different entities such as financial institutions (e.g., banks, credit processing systems, ATM systems, or others). In particular, the device account consolidation system 100 can send and receive network communications (e.g., via the network(s) 1604) to link the third-party system(s) 1608. For example, the device account consolidation system 100 may receive authentication credentials from a user to link the third-party system(s) 1608 such as an online bank account, credit account, debit account, or other financial account to a user account within the device account consolidation system 100. The device account consolidation system 100 can subsequently communicate with the third-party system(s) 1608 to detect or identify balances, transactions, withdrawal, transfers, deposits, credits, debits, or other transaction types associated with the third-party system(s) 1608. The device account consolidation system 100 can further provide the aforementioned or other financial information associated with the third-party system(s) 1608 for display via the client device(s) 1606. In some cases, the device account consolidation system 100 links more than one of the third-party system(s) 1608, receiving account information for accounts associated with each respective third-party system of the third-party system(s) 1608 and performing operations or transactions between the different systems via authorized network connections.

In particular embodiments, the device account consolidation system 100 may interface between an online banking system and a credit processing system via the network(s) 1604. For example, the device account consolidation system 100 can provide access to a bank account of the third-party system(s) 1608 and linked to a user account within the device account consolidation system 100. Indeed, the device account consolidation system 100 can facilitate access to, and transactions to and from, the bank account of the third-party system(s) 1608 via a client application of the device account consolidation system 100 on the client device(s) 1606. The device account consolidation system 100 can also communicate with a credit processing system, an ATM system, and/or other financial systems (e.g., via the network(s) 1604) to authorize and process credit charges to a credit account, perform ATM transactions, perform transfers (or other transactions) across accounts of different third-party systems of the third-party system(s) 1608, and to present corresponding information via the client device(s) 1606.

In particular embodiments, the device account consolidation system 100 includes a model for approving or denying transactions. For example, the device account consolidation system 100 includes a transaction approval machine learning model that is trained based on training data such as user account information (e.g., name, age, location, and/or income), account information (e.g., current balance, average balance, maximum balance, and/or minimum balance), credit usage, and/or other transaction history. Based on one or more of these data (from the device account consolidation system 100 and/or the third-party system(s) 1608), the device account consolidation system 100 can utilize the transaction approval machine learning model to generate a prediction (e.g., a percentage likelihood) of approval or denial of a transaction (e.g., a withdrawal, a transfer, or a purchase) across one or more networked systems.

The device account consolidation system 100 may be accessed by the other components of network environment 1600 either directly or via the network(s) 1604. In particular embodiments, the device account consolidation system 100 may include one or more servers. Each server may be a unitary server or a distributed server spanning multiple computers or multiple datacenters. Servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by the server. In particular embodiments, the device account consolidation system 100 may include one or more data stores. Data stores may be used to store various types of information. In particular embodiments, the information stored in data stores may be organized according to specific data structures. In particular embodiments, each data store may be a relational, columnar, correlation, or other suitable database. Although this disclosure describes or illustrates particular types of databases, this disclosure contemplates any suitable types of databases. Particular embodiments may provide interfaces that enable the client device(s) 1606, or the device account consolidation system 100 to manage, retrieve, modify, add, or delete, the information stored in a data store.

In particular embodiments, the device account consolidation system 100 may provide users with the ability to take actions on various types of items or objects, supported by the device account consolidation system 100. As an example, and not by way of limitation, the items and objects may include financial institution networks for banking, credit processing, or other transactions, to which users of the device account consolidation system 100 may belong, computer-based applications that a user may use, transactions, interactions that a user may perform, or other suitable items or objects. A user may interact with anything that is capable of being represented in the device account consolidation system 100 or by an external system of a third-party system, which is separate from the device account consolidation system 100 and coupled to the device account consolidation system 100 via the network(s) 1604.

In particular embodiments, the device account consolidation system 100 may be capable of linking a variety of entities. As an example, and not by way of limitation, the device account consolidation system 100 may enable users to interact with each other or other entities, or to allow users to interact with these entities through an application programming interfaces (“API”) or other communication channels.

In particular embodiments, the device account consolidation system 100 may include a variety of servers, sub-systems, programs, modules, logs, and data stores. In particular embodiments, the device account consolidation system 100 may include one or more of the following: a web server, action logger, API-request server, transaction engine, cross-institution network interface manager, notification controller, action log, third-party-content-object-exposure log, inference module, authorization/privacy server, search module, user-interface module, user-profile (e.g., provider profile or requester profile) store, connection store, third-party content store, or location store. The device account consolidation system 100 may also include suitable components such as network interfaces, security mechanisms, load balancers, failover servers, management-and-network-operations consoles, other suitable components, or any suitable combination thereof. In particular embodiments, the device account consolidation system 100 may include one or more user-profile stores for storing user profiles for transportation providers and/or transportation requesters. A user profile may include, for example, biographic information, demographic information, financial information, behavioral information, social information, or other types of descriptive information, such as interests, affinities, or location.

The web server may include a mail server or other messaging functionality for receiving and routing messages between the device account consolidation system 100 and the client device(s) 1606. An action logger may be used to receive communications from a web server about a user’s actions on or off the device account consolidation system 100. In conjunction with the action log, a third-party-content-object log may be maintained of user exposures to third-party-content objects. A notification controller may provide information regarding content objects to the client device(s) 1606. Information may be pushed to the client device(s) 1606 as notifications, or information may be pulled from the client device(s) 1606 responsive to a request received from the client device(s) 1606. Authorization servers may be used to enforce one or more privacy settings of the users of the device account consolidation system 100. A privacy setting of a user determines how particular information associated with a user can be shared. The authorization server may allow users to opt in to or opt out of having their actions logged by the device account consolidation system 100 or shared with other systems, such as, for example, by setting appropriate privacy settings. Third-party-content-object stores may be used to store content objects received from third parties. Location stores may be used for storing location information received from the client device(s) 1606 associated with users.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
receiving, via one or more interactions with a graphical user interface of a client device having a collection of digital asset accounts within a digital system, a request to view transfers corresponding to the collection of digital asset accounts, the collection of digital asset accounts comprising:
a digital asset deposit account,
a limited digital asset account comprising a threshold transmission limit, and
a secured digital asset deposit account that is linked to the limited digital asset account to set the threshold transmission limit for the limited digital asset account; and
in response to the request:
extracting transfer information from each digital asset account of the collection of digital asset accounts;
generating a filtered consolidated digital report using the transfer information from each digital asset account by filtering sweeping transfers between the collection of digital asset accounts; and
providing, for display within the graphical user interface of the client device, the filtered consolidated digital report as part of a graphical representation of a single digital asset account that represents the collection of digital asset accounts.

2. The computer-implemented method of claim 1, wherein generating the filtered consolidated digital report by filtering the sweeping transfers between the collection of digital asset accounts comprises:
extracting, from the transfer information of each digital asset account, a set of deposits into the collection of digital asset accounts and a set of withdrawals from the collection of digital asset accounts;
extracting, from the transfer information of each digital asset account, one or more sweeping transfers executed in support of the set of deposits and the set of withdrawals; and
generating the filtered consolidated digital report to include the set of deposits and the set of withdrawals and to exclude the one or more sweeping transfers.

3. The computer-implemented method of claim 1, further comprising:
generating an account statement for the digital asset deposit account that includes:
a set of deposits into the digital asset deposit account;
a set of withdrawals from the digital asset deposit account; and
a set of sweeping transfers between the digital asset deposit account and the secured digital asset deposit account executed in support of the set of deposits and the set of withdrawals; and
providing the account statement for display within the graphical user interface of the client device in response to a user interaction to view the account statement.

4. The computer-implemented method of claim 1, further comprising:
providing, for display, within the graphical user interface of the client device, a selectable option corresponding to the single digital asset account as a source account in a transfer of one or more digital assets; and
transmitting, based on a user selection of the selectable option, the one or more digital assets from the digital asset deposit account represented by the single digital asset account to an additional digital asset account.

5. The computer-implemented method of claim 1, further comprising:
providing, for display, within the graphical user interface of the client device, a selectable option corresponding to the single digital asset account as a destination account in a transfer of one or more digital assets; and
transmitting, in response to detecting a user selection of the selectable option, the one or more digital assets from an additional digital asset account to the digital asset deposit account represented by the single digital asset account.

6. The computer-implemented method of claim 1, further comprising:
generating a consolidated digital asset value by combining a first digital asset value of the digital asset deposit account and a second digital asset value of the secured digital asset deposit account; and
providing, for display within the graphical user interface of the client device, the consolidated digital asset value as part of the graphical representation of the single digital asset account.

7. The computer-implemented method of claim 6, further comprising:
modifying the consolidated digital asset value for the single digital asset account in response to a first transfer of one or more digital assets involving the digital asset deposit account;
updating the modified consolidated digital asset value for the single digital asset account in response to a second transfer of one or more additional digital assets involving the secured digital asset deposit account; and
providing, for display within the graphical user interface of the client device, the updated consolidated digital asset value as part of the graphical representation of the single digital asset account.

8. The computer-implemented method of claim 6, wherein providing the consolidated digital asset value for display within the graphical user interface of the client device comprises providing the consolidated digital asset value for display while hiding individual digital asset values of the collection of digital asset accounts from display.

9. The computer-implemented method of claim 1, further comprising:
providing, for display within the graphical user interface, an interactive option for further filtering the filtered consolidated digital report by digital asset account; and
modifying, within the graphical user interface, the filtered consolidated digital report to show transfers involving the digital asset account from the collection of digital asset accounts selected via a user interaction with the interactive option and hide other transfers involving other digital asset accounts from the collection of digital asset accounts.

10. A system comprising:
at least one processor; and
a non-transitory computer-readable medium storing instructions that, when executed by the at least one processor, cause the system to:
receive, via one or more interactions with a graphical user interface of a client device having a collection of digital asset accounts within a digital system, a request to view transfers corresponding to the collection of digital asset accounts, the collection of digital asset accounts comprising:
a digital asset deposit account,
a limited digital asset account comprising a threshold transmission limit, and
a secured digital asset deposit account that is linked to the limited digital asset account to set the threshold transmission limit for the limited digital asset account; and
in response to the request:
extract transfer information from each digital asset account of the collection of digital asset accounts;
generate a filtered consolidated digital report using the transfer information from each digital asset account by filtering sweeping transfers between the collection of digital asset accounts; and
provide, for display within the graphical user interface of the client device, the filtered consolidated digital report as part of a graphical representation of a single digital asset account that represents the collection of digital asset accounts.

11. The system of claim 10, further comprising instructions that, when executed by the at least one processor, cause the system to generate the filtered consolidated digital report by filtering the sweeping transfers between the collection of digital asset accounts by:
extracting, from the transfer information of each digital asset account, a set of deposits into the collection of digital asset accounts and a set of withdrawals from the collection of digital asset accounts;
extracting, from the transfer information of each digital asset account, one or more sweeping transfers executed in support of the set of deposits and the set of withdrawals; and
generating the filtered consolidated digital report to include the set of deposits and the set of withdrawals and to exclude the one or more sweeping transfers.

12. The system of claim 10, further comprising instructions that, when executed by the at least one processor, cause the system to:
generate an account statement for the digital asset deposit account that includes:
a set of deposits into the digital asset deposit account;
a set of withdrawals from the digital asset deposit account; and
a set of sweeping transfers between the digital asset deposit account and the secured digital asset deposit account executed in support of the set of deposits and the set of withdrawals; and
provide the account statement for display within the graphical user interface of the client device in response to a user interaction to view the account statement.

13. The system of claim 10, further comprising instructions that, when executed by the at least one processor, cause the system to:
provide, for display, within the graphical user interface of the client device, a selectable option corresponding to the single digital asset account as a source account in a transfer of one or more digital assets; and
transmit, based on a user selection of the selectable option, the one or more digital assets from the digital asset deposit account represented by the single digital asset account to an additional digital asset account.

14. The system of claim 10, further comprising instructions that, when executed by the at least one processor, cause the system to:
provide, for display, within the graphical user interface of the client device, a selectable option corresponding to the single digital asset account as a destination account in a transfer of one or more digital assets; and
transmit, in response to detecting a user selection of the selectable option, the one or more digital assets from an additional digital asset account to the digital asset deposit account represented by the single digital asset account.

15. The system of claim 10, further comprising instructions that, when executed by the at least one processor, cause the system to:
generate a consolidated digital asset value by combining a first digital asset value of the digital asset deposit account and a second digital asset value of the secured digital asset deposit account; and
provide, for display within the graphical user interface of the client device, the consolidated digital asset value as part of the graphical representation of the single digital asset account.

16. The system of claim 15, further comprising instructions that, when executed by the at least one processor, cause the system to:
modify the consolidated digital asset value for the single digital asset account in response to a first transfer of one or more digital assets involving the digital asset deposit account;
update the modified consolidated digital asset value for the single digital asset account in response to a second transfer of one or more additional digital assets involving the secured digital asset deposit account; and
provide, for display within the graphical user interface of the client device, the updated consolidated digital asset value as part of the graphical representation of the single digital asset account.

17. The system of claim 15, further comprising instructions that, when executed by the at least one processor, cause the system to provide the consolidated digital asset value for display within the graphical user interface of the client device by providing the consolidated digital asset value for display while hiding individual digital asset values of the collection of digital asset accounts from display.

18. A non-transitory computer-readable medium storing instructions that, when executed by at least one processor, cause a computing device to:
receive, via one or more interactions with a graphical user interface of a client device having a collection of digital asset accounts within a digital system, a request to view transfers corresponding to the collection of digital asset accounts, the collection of digital asset accounts comprising:
a digital asset deposit account,
a limited digital asset account comprising a threshold transmission limit, and
a secured digital asset deposit account that is linked to the limited digital asset account to set the threshold transmission limit for the limited digital asset account; and
in response to the request:
extract transfer information from each digital asset account of the collection of digital asset accounts;
generate a filtered consolidated digital report using the transfer information from each digital asset account by filtering sweeping transfers between the collection of digital asset accounts; and
provide, for display within the graphical user interface of the client device, the filtered consolidated digital report as part of a graphical representation of a single digital asset account that represents the collection of digital asset accounts.

19. The non-transitory computer-readable medium of claim 18, further comprising instructions that, when executed by the at least one processor, cause the computing device to generate the filtered consolidated digital report by filtering the sweeping transfers between the collection of digital asset accounts by:
extracting, from the transfer information of each digital asset account, a set of deposits into the collection of digital asset accounts and a set of withdrawals from the collection of digital asset accounts;
extracting, from the transfer information of each digital asset account, one or more sweeping transfers executed in support of the set of deposits and the set of withdrawals; and
generating the filtered consolidated digital report to include the set of deposits and the set of withdrawals and to exclude the one or more sweeping transfers.

20. The non-transitory computer-readable medium of claim 18, further comprising instructions that, when executed by the at least one processor, cause the computing device to:
provide, for display within the graphical user interface, an interactive option for further filtering the filtered consolidated digital report by digital asset account; and
modify, within the graphical user interface, the filtered consolidated digital report to show transfers involving the digital asset account from the collection of digital asset accounts selected via a user interaction with the interactive option and hide other transfers involving other digital asset accounts from the collection of digital asset accounts.
